(19) United States
(12) Patent Application Publication
(10) Pub. No.: US 2025/0093046 A1
(43) Pub. Date: Mar. 20, 2025

(54) COOKING APPARATUS

(71) Applicant: SAMSUNG ELECTRONICS CO., LTD., Suwon-si (KR)

(72) Inventors: Jihun HWANG, Suwon-si (KR); Junyoung LEE, Suwon-si (KR); Sungwook KANG, Suwon-si (KR); Moonkyu KIM, Suwon-si (KR); Geunyong PARK, Suwon-si (KR); Jonghoon LEE, Suwon-si (KR); Hongman CHANG, Suwon-si (KR)

(73) Assignee: SAMSUNG ELECTRONICS CO., LTD., Suwon-si (KR)

(21) Appl. No.: 18/821,477

(22) Filed: Aug. 30, 2024

Related U.S. Application Data
(63) Continuation of application No. PCT/KR2024/009537, filed on Jul. 5, 2024.

(30) Foreign Application Priority Data
Sep. 15, 2023 (KR) 10-2023-0123501

(51) Int. Cl. F24C 7/08; F24C 3/12

(52) U.S. Cl. CPC F24C 7/082; F24C 3/124

(57) ABSTRACT

A cooking apparatus includes a housing, a heat source on one side of the housing, a control panel couplable to the housing, a knob rotatably mountable on the control panel to operate the heat source and movable rearwardly, a stopper between the control panel and the knob and including an anti-rotation portion configured to prevent a rotation of the knob, a button movably couplable to the knob in a left-to-right direction, and a locking pin accommodated in the anti-rotation portion and secured to the button so as to move along the button. The locking pin is deviated from the anti-rotation portion based on movement of the button, the knob is rotatable while the knob is moved rearwardly and the locking pin is deviated from the anti-rotation portion, and the knob is rotated to operate the heat source.

### CROSS-REFERENCE TO RELATED APPLICATIONS

This application is a continuation application of PCT/KR2024/009537, filed on Jul. 5, 2024, which claims priority to Korean Patent Application No. 10-2023-0123501, filed on Sep. 15, 2023, the contents of all of which are incorporated herein by reference.

### TECHNICAL FIELD

The disclosure relates to a cooking apparatus including a knob.

### BACKGROUND ART

In general, a cooking apparatus is an appliance that cooks food by having a cooking chamber, a heating device that applies heat to the cooking chamber, and a circulating device that circulates the heat generated by the heating device within the cooking chamber. A cooking apparatus is also an appliance that cooks food by enclosing and heating the food, and may typically be classified into electric, gas, and electronic types depending on a heat source of the heating device. For example, an electric oven uses heat from a heater driven by electricity as a heat source, a gas oven uses heat from gas as a heat source, and a microwave oven uses frictional heat from water molecules caused by high frequency waves as a heat source.

The cooking apparatus may be provided with a control panel on one of the front side or the upper side of a main body. The control panel may be provided with a plurality of buttons, keypads, and/or knobs configured to allow a user to set a desired cooking mode or to set various conditions required for cooking.

For example, a control device for controlling the heating device may be operable in a push and turn manner. A knob arranged to operate the control device is pushed to press a control shaft of the control device, and the knob may then control the operation of the cooking apparatus by a mechanism in which the knob turns.

However, in the case that a user accidently presses and turns the knob, the heating device may be activated, resulting in a fire or burns to the user.

### DISCLOSURE

### Technical Problem

An aspect of the present disclosure provides a cooking apparatus capable of preventing malfunction of a knob.

Further, an aspect of the present disclosure provides a cooking apparatus capable of preventing burns and fires caused by malfunction of a knob.

Further, an aspect of the present disclosure provides a cooking apparatus having increased durability due to the prevention of damage to configurations.

Technical tasks to be achieved in this document are not limited to the technical tasks mentioned above, and other technical tasks not mentioned will be clearly understood by those skilled in the art from the description below.

### Technical Solution

According to an embodiment of the present disclosure, a cooking apparatus includes a housing, a heat source on one side of the housing, a control panel couplable to the housing, a knob rotatably mountable on the control panel to operate the heat source and movable rearwardly, a stopper disposed between the control panel and the knob and including an anti-rotation portion configured to prevent rotation of the knob, a button movably couplable to the knob in a left-to-right direction, and a locking pin accommodated in the anti-rotation portion and secured to the button so as to move along the button, wherein the locking pin is deviated from the anti-rotation portion based on movement of the button, the knob is rotatable while the knob is moved rearwardly and the locking pin is deviated from the anti-rotation portion, and the knob is rotated to operate the heat source.

The rotation of the knob may be prevented while the locking pin is accommodated in the anti-rotation portion.

The locking pin may be movable between a first pin position in which the rotation of the knob may be locked by being accommodated in the anti-rotation portion and a second pin position in which the rotation of the knob may be unlocked by being deviated from the anti-rotation portion, and the anti-rotation portion may include a stopper groove in which the locking pin may be accommodated at the first pin position of the locking pin, and while the button is moved in the left-to-right direction, the locking pin may be moved from the first pin position to the second pin position to allow the locking pin to be deviated from the stopper groove.

The button may be configured to rotate along the knob at the second pin position of the locking pin, after the knob and the button are rotated at a predetermined angle, the locking pin may be movable to the first pin position.

The knob and the button may be rotatable while the locking pin is at the first pin position after the knob and the button are rotated at the predetermined angle.

The stopper may comprise a hollow portion, an perimeter wall forming the hollow portion, and a protruding wall protruding from the perimeter wall and on which the stopper groove may be formed.

The button may comprise a first pressing portion and a second pressing portion arranged in one direction, a first rack extending from the first pressing portion toward the second pressing portion, a second rack extending from the second pressing portion toward the first pressing portion, and a pinion disposed between the first rack and the second rack so as to be rotatable based on the first pressing portion and the second pressing portion being pressed.

The button may further include a spring disposed between the first pressing portion and the second pressing portion to press the first pressing portion and the second pressing portion.

The control panel may be disposed on a front side of the housing, and the button may further comprise a first guide portion extending in left-to-right direction from a rear end of the first pressing portion, a second guide portion extending in left-to-right direction from a rear end of the second pressing portion, and a guide groove formed in the first guide portion and the second guide portion in the left-to-right direction to guide the movement of the first pressing portion and the second pressing portion.

The cooking apparatus may further comprise a weight disposed on a front side of the stopper. The weight may comprise a base, and a guide rail protruding from the base toward the button and arranged in in the left-to-right direction so as to be inserted into the guide groove.

The knob may include a receiving space configured to receive the button, and the first pressing portion and the second pressing portion may be exposed from the receiving space to be pressed.

The cooking apparatus may further comprise a weight disposed on a front side of the stopper. The weight may comprise a base, a pinion mounting portion protruding from the base to allow the pinion to be mounted, and a guide hole formed in the base to guide the movement of the locking pin.

The cooking apparatus may further comprise a stopper holder coupled to the control panel to secure the stopper.

The stopper holder may comprise a fixing portion to which the stopper may be secured, a light source substrate disposed outside the fixing portion and electrically connected to a light source, and a light diffusion portion disposed outside the fixing portion to diffuse light emitted from the light source.

The control panel may be configured to partially cover a front side of the housing, and the knob may be movable between a first knob position and a second knob position moved rearwardly from the first knob position.

The cooking apparatus may further comprise a regulator disposed on a rear side of the control panel to operate the heat source in response to the rotation of the knob, a shaft coupled to the regulator to be movable from a first shaft position in which rotation with respect to the regulator is restricted at the first knob position of the knob to a second shaft position rotatable with respect to the regulator at the second knob position so as to operate the heat source, a fixing protrusion protruding from the shaft in a radial direction of the shaft, and a fixing groove formed in the regulator to receive the fixing protrusion while the shaft is positioned at the first shaft position.

Based on the knob being moved toward the control panel, the shaft may be moved to the second shaft position.

The cooking apparatus may further comprise a processor configured to cause control the regulator to generate a signal based on the rotation of the knob, and to operate the heat source in response to the signal generated by the regulator.

According to an embodiment of the present disclosure, a cooking apparatus may include a housing, a heat source on one side of the housing, a control panel coupled to the housing, a knob rotatably mounted on the control panel so as to operate the heat source, a button movably coupled to the knob, a stopper between the control panel and the button and including an anti-rotation portion configured to prevent a rotation of the knob, and a locking pin secured to the button so as to be received in the anti-rotation portion and configured to prevent the rotation of the knob while the locking pin is received in the anti-rotation portion.

According to an embodiment of the present disclosure, the knob may be movable between a first knob position in which rotation is prevented, and a second knob position moved in a first direction from the first knob position, the button is movable in a direction different from the first direction between a first button position in which the pin is locked by the stopper to prevent rotation of the knob, and a second button position in which the pin is unlocked from the stopper, and based on the knob being at the second knob position and the button being at the second button position, the knob may be rotated to operate the heat source.

According to an embodiment of the present disclosure, a cooking apparatus may include a housing, a heat source on one side of the housing, a control panel to cover a portion of a front side of the housing, a knob mounted on the control panel so as to operate the heat source and configured to be movable toward the control panel, a button movably coupled to the knob, a pin including a first pin position secured to the button so as to be moved based on the button being moved and a second pin position moved from the first pin position based on the button being moved, and a stopper disposed between the control panel and the button and including an anti-rotation portion contactable with the pin at the first pin position of the knob to prevent the knob from moving toward the control panel, wherein based on the knob being moved toward the control panel and the pin being at the second pin position, the knob may be rotated.

### DESCRIPTION OF DRAWINGS

FIG. 1 is a perspective view illustrating a cooking apparatus according to an embodiment.

FIG. 2 is a front view illustrating the cooking apparatus according to an embodiment.

FIG. 3 is a cross-sectional view illustrating the cooking apparatus according to an embodiment.

FIG. 4 is an exploded perspective view illustrating a knob assembly in the cooking apparatus according to an embodiment.

FIG. 5 is an exploded perspective view illustrating the knob assembly in the cooking apparatus according to an embodiment.

FIG. 6 is a cross-sectional view illustrating the knob assembly in the cooking apparatus according to an embodiment.

FIG. 7 is a cross-sectional view illustrating the knob assembly in the cooking apparatus according to an embodiment.

FIG. 8 is a perspective view illustrating a coupling of some configurations of the knob assembly in the cooking apparatus according to an embodiment.

FIG. 9 is a perspective view illustrating a coupling of some configurations of the knob assembly in the cooking apparatus according to an embodiment.

FIG. 10 is a perspective view illustrating a regulator in the cooking apparatus according to an embodiment.

FIG. 11 is an exploded perspective view illustrating the regulator in the cooking apparatus according to an embodiment.

FIG. 12 is a cross-sectional view illustrating the regulator in the cooking apparatus according to an embodiment.

FIG. 13 is a perspective view illustrating a partial configuration of the regulator in the cooking apparatus according to an embodiment.

FIG. 14 is a schematic view illustrating some configurations of the cooking apparatus according to an embodiment.

FIG. 15 is a schematic view illustrating some configurations of the cooking apparatus according to an embodiment.

FIG. 16 is a schematic view illustrating some configurations of the cooking apparatus according to an embodiment.

FIG. 17 is a schematic view illustrating some configurations of the cooking apparatus according to an embodiment.

FIG. 18 is a schematic view illustrating some configurations of the cooking apparatus according to an embodiment.

FIG. 19 is a schematic view illustrating some configurations of the cooking apparatus according to an embodiment.

FIG. 20 is a schematic view illustrating some configurations of the cooking apparatus according to an embodiment.

FIG. 21 is a schematic view illustrating some configurations of the cooking apparatus according to an embodiment.

FIG. 22 is a schematic view illustrating some configurations of the cooking apparatus according to an embodiment.

FIG. 23 is a schematic view illustrating some configurations of the cooking apparatus according to an embodiment.

FIG. 24 is a perspective view illustrating the stopper in the cooking apparatus according to an embodiment.

### MODES OF THE INVENTION

Embodiments described in the disclosure and configurations shown in the drawings are merely examples of the embodiments of the disclosure and may be used in various different ways at the time of filing of the present application to replace the embodiments and drawings of the disclosure.

In addition, the same reference numerals or signs shown in the drawings of the disclosure indicate elements or components performing substantially the same function.

Also, the terms used herein are used to describe the embodiments and are not intended to limit and/or restrict the disclosure. The singular forms “a,” “an” and “the” are intended to include the plural forms as well, unless the context clearly indicates otherwise. In this disclosure, the terms “including”, “having”, and the like are used to specify features, figures, steps, operations, elements, components, or combinations thereof, but do not preclude the presence or addition of one or more of the features, figures, steps, operations, elements, components, or combinations thereof.

The expressions “A or B”, “at least one of A or/and B” or “one or more of A or/and B”, “A, B or C”, “at least one of A, B or/and C” or “one or more of A, B or/and C”, and the like used herein may include any and all combinations of one or more of the associated listed items.

The term of “and/or” includes a plurality of combinations of relevant items or any one item among a plurality of relevant items.

It will be understood that, although the terms “first”, “second”, “primary”, “secondary”, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

Also, as used in the disclosure, “identical” includes having similar properties or being similar within a certain range. Identical also means “substantially identical”. Substantially identical is to be understood to include within the scope of “identical” figures that fall within the margin of error in manufacturing or figures that fall within the scope of differences that are not meaningful with respect to a reference figure.

In addition, terms such as “part”, “portion”, “unit”, “block”, “member”, “element”, “component”, “module”, and the like may refer to a unit that handles at least one function or operation. For example, these terms may refer to at least one piece of hardware, such as a field-programmable gate array (FPGA) or an application specific integrated circuit (ASIC), at least one piece of software stored in memory, or at least one process performed by a processor.

In the following detailed description, the terms of “front”, “forward”, “rear”, “backward”, “top”, “bottom”, “upper”, “lower”, “left”, and “right” may be defined by the drawings, but the shape and the location of the component is not limited by the term.

Hereinafter, various embodiments according to the disclosure will be described in detail with reference to the accompanying drawings.

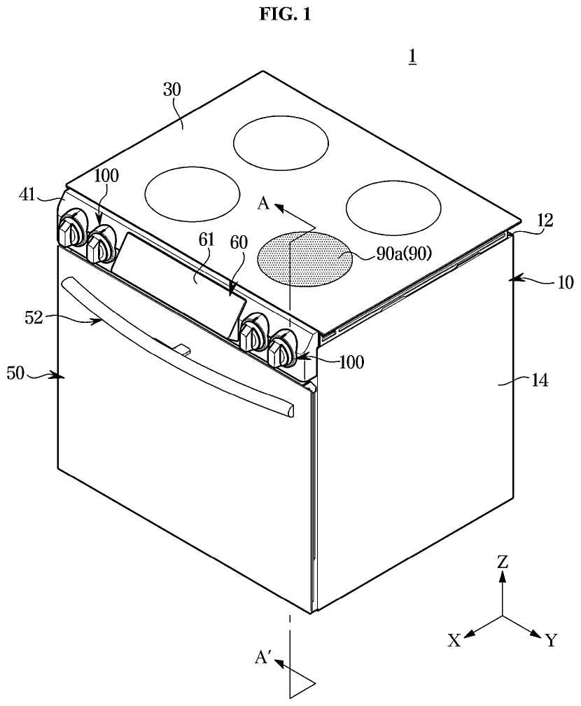

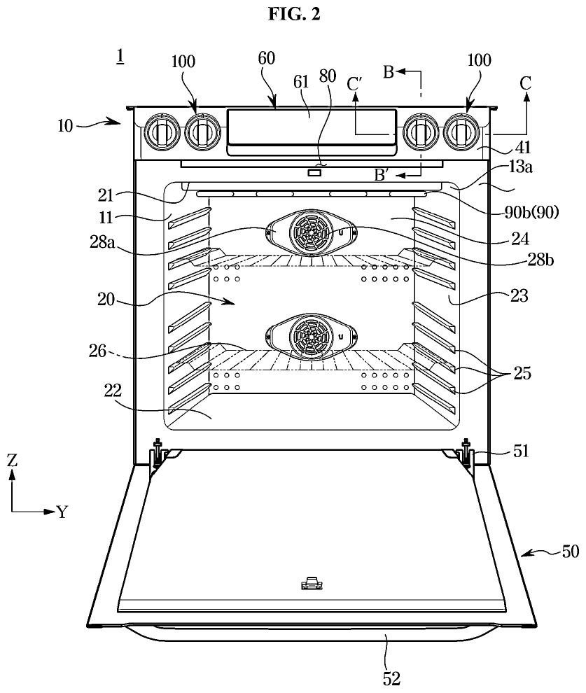

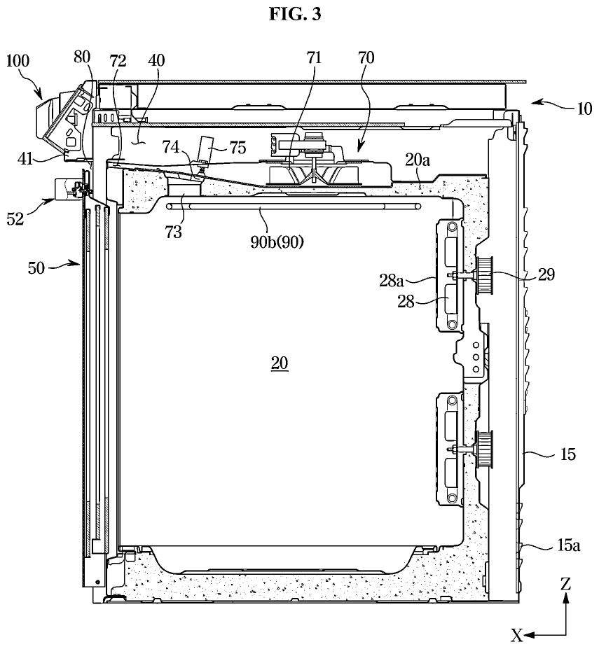

FIG. 1 is a perspective view of a cooking apparatus according to an embodiment. FIG. 2 is a front view of the cooking apparatus according to an embodiment. FIG. 3 is a cross-sectional view of the cooking apparatus according to an embodiment. In particular, FIG. 3 is the cross-sectional view taken along line A-A′ shown in FIG. 1.

Referring to FIGS. 1 to 3, a cooking apparatus according to an embodiment may include a housing 10. The housing 10 may include an outer housing 12 and an inner housing 11. The inner housing 11 and the outer housing 12 may each have a substantially box shape with an open front.

The cooking apparatus 1 may include a cooktop 30 disposed on an upper side of the housing 10 and on which a container containing food may be placed and heated. The cooktop 30 may be provided with at least one heating portion 90a. The container containing food may be positioned within the heating portion 90a and heated directly.

The cooking apparatus 1 may include a door 50 provided on a front side of the housing 10 to open or close a cooking chamber 20. For example, the door 50 may open or close an opening 13a of a front panel 13.

The housing 10 may include the front panel 13 forming a front of the housing 10, a side panel 14 forming a side of the outer housing 12, and a rear panel 15 forming a rear of the housing 10.

The front panel 13 may be provided with the opening 13a, and the cooking chamber 20 provided in the housing 10 may be opened and closed through the opening 13a.

The cooking apparatus according to an embodiment may further include a control panel 41. The control panel 41 may be disposed on an upper portion of the housing 10. A knob assembly 100 that operates a heat source 90 and a display module 60 that displays operational information of the cooking apparatus 1 may be coupled and/or mounted to the control panel 41. The control panel 41 may be disposed on an upper portion of the front panel 13 and may cover a front side of an electrical compartment 40.

The control panel 41 may be positioned on at least a portion of the housing 10. According to an embodiment, the control panel 41 may be disposed on a side of the front side of the housing 10. However, the present disclosure is not limited thereto, and the control panel 41 may be disposed on an upper surface of the housing 10 or may form one surface of the housing 10.

The control panel 41 may also be a configuration included in the housing 10.

The rear panel 15 may be provided with an inlet 15a to allow air to be drawn into the electrical compartment 40. The air drawn into the electrical compartment 40 through the inlet 15a may flow inside the electrical compartment 40 and cool the electrical components. However, the position of the inlet 15a is not limited thereto and the inlet 15a may be located in any position as long as it may draw in air from outside and guide the drawn air into the electrical compartment 40.

The cooking chamber 20 may be formed by an upper panel 21, a lower panel 22, side panels 23, and a rear panel 24. The cooking chamber 20 may be a cooking space, which is open at the front through the opening 13a of the front panel 13 to allow food to be placed in and out.

A plurality of supports 25 may be provided on an inner surface of the two side plates 23. At least one detachable rack 26 on which food may be placed may be mounted on the plurality of supports 25.

The plurality of supports 25 may be provided with rails (not shown) to allow the rack 26 to slide. A user may move the rack 26 along the rails (not shown) to remove or place food.

The plurality of supports 25 may be detachably mounted with one or more dividers (not shown) that may divide the cooking chamber 20 into a plurality of sections. The plurality of sections of the cooking chamber 20 divided by the dividers may need not be of the same size, and may each be of a different size.

This may allow the user to utilize the space of the plurality of divided sections of the cooking chamber 20 in different ways according to his/her intention. The divider may be formed of a thermal insulating material to insulate each cooking chamber 20.

A heater 90b for heating food may be provided in the cooking chamber 20. The heater 90b may be an electric heater including an electric resistance. However, the heater 90b is not limited thereto and may be a gas heater that generates heat by burning gas. In other words, the cooking apparatus 1 may include an electric oven and a gas oven.

The cooking apparatus 1 may include the heat source 90. The heat source 90 may be configured to heat food items.

The heat source 90 may include the heating portion 90a and the heater 90b described above.

The rear panel 24 of the cooking chamber 20 may be provided with a circulation fan 28 that circulates the air in the cooking chamber 20 to heat the food uniformly, and a circulation motor 29 that drives the circulation fan 28.

A fan cover 28a may be provided on a front side of the circulation fan 28 to cover the circulation fan 28, and outlet holes 28b through which air may flow may be formed in the fan cover 28a.

The front side of the cooking chamber 20 may be opened and closed by the door 50, and the door 50 may be coupled to the housing 10 by a hinge 51 provided at a lower portion of the housing 10 so as to be rotatable with respect to the housing 10.

A handle 52 may be provided on a front upper portion of the door 50 for gripping by the user to open or close the cooking chamber 20.

The display module 60, which is configured to display various operational information of the cooking apparatus 1 and allow the user to input operational commands, may be mounted on the control panel 41 provided at the upper front portion of the front panel 13.

The display module 60 may include a display, and the display may display electrical information as visual information. The display may include a display panel that displays an image, and a light source device that supplies light to the display panel, and a light emitting diode (LED) may be used as the light source device.

The display module 60 may include a cover panel 61 provided on a front side of the display panel. The cover panel 61 may simply be a protective panel for protecting the display panel, or may be a touch panel that may receive a touch command from the user.

The control panel 41 may be provided with the knob assembly 100 capable of operating the cooking apparatus 1. The knob assembly 100 may be coupled and/or secured to the control panel 41.

In an embodiment, four knob assemblies 100 may be provided. However, the number of knob assemblies is not limited thereto.

An insulation 20a may be disposed between the electrical compartment 40 and the cooking chamber 20 to insulate the electrical compartment 40 and the cooking chamber 20 to prevent heat from the cooking chamber 20 from being transferred to the electrical compartment 40.

The insulation 20a may cover not only a space between the electrical compartment 40 and the cooking chamber 20 but also an entire outside of the cooking chamber 20 to prevent heat from the cooking chamber 20 from being transferred to the outside of the cooking apparatus 1.

Since the temperature in the electrical compartment 40 may be increased by the heat of various electrical components, the cooking apparatus 1 is provided with a blower 70 that may cool the electrical compartment 40 by circulating air around the electrical compartment 40.

The blower 70 may include a blower fan 71 for flowing air, and a discharge flow path 72 configured to discharge the air drawn by the blower fan 71 to the front side of the cooking apparatus 1.

The blower fan 71 may draw in air in an axial direction and then discharge the drawn-in art in a radial direction. In other words, the blower fan 71 according to an embodiment may be a centrifugal fan. Alternatively, the blower fan 71 may include an axial fan.

Air from the outside may be drawn into the electrical compartment 40 through the inlet 15a formed in the rear panel 15, and the air drawn into the electrical compartment 40 may flow inside the electrical compartment 40 to cool the electrical components, and then be discharged to the front side of the cooking apparatus 1 through an outlet 80 along the discharge flow path 72.

The outlet 80 may include a space between the front panel 13 and the control panel 41. However, the present disclosure is not limited thereto and the outlet 80 may be provided in different positions and have different shapes as long as the air drawn in through the inlet 15a may be discharged to the outside of the main body 1.

A portion of the air in the cooking chamber 20 may be drawn into the discharge flow path 72 through a cooking chamber flow path 73 and discharged to the front side of the cooking apparatus 1.

A bypass hole 74 may be formed in the discharge flow path 72 to allow a portion of the air flowing from the discharge flow path 72 to the outlet 80 to enter the cooking chamber flow path 73, and the bypass hole 74 may be opened and closed by an opening/closing device 75.

Based on the opening and closing of the bypass hole 74 by the opening/closing device 75, the amount of air flowing from the discharge flow path 72 to the outlet 80 to enter the cooking chamber flow path 73 may be regulated. As a result, the amount of air discharged from the cooking chamber 20 to the cooking chamber flow path 73 may be regulated.

The door 50, which is rotatably coupled to the front side of the housing 10 and opens or closes the cooking chamber 20 and the opening 13a, may include a plurality of glasses. A space may be formed between the plurality of glasses, and the door 50 may dissipate heat as the space is configured to allow air from the outside to enter and circulate therein.

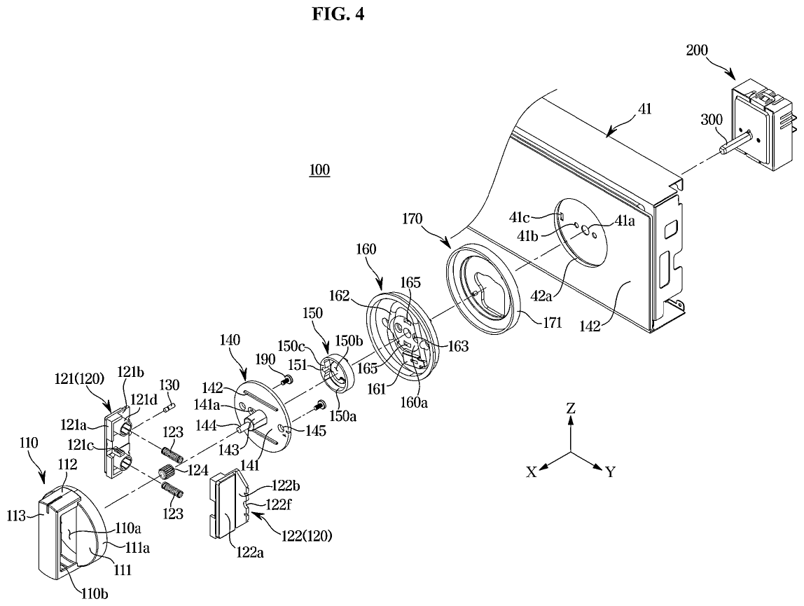

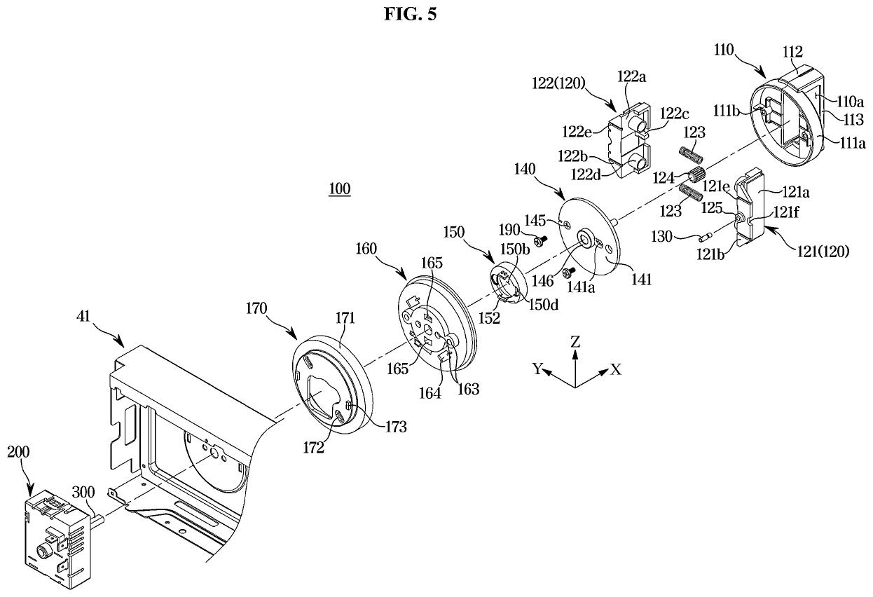

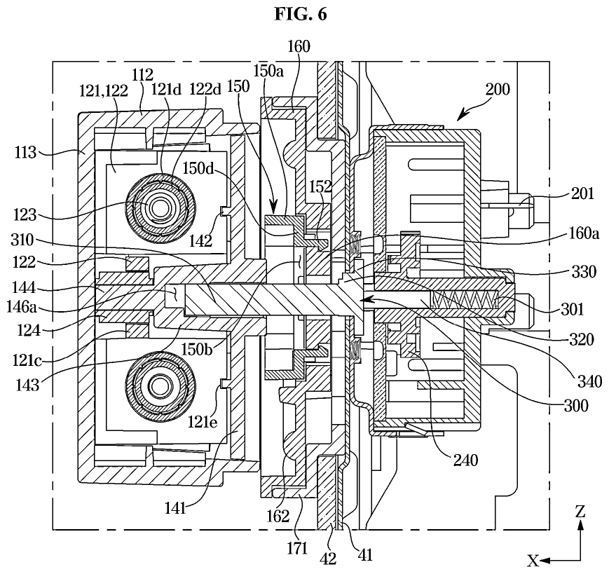

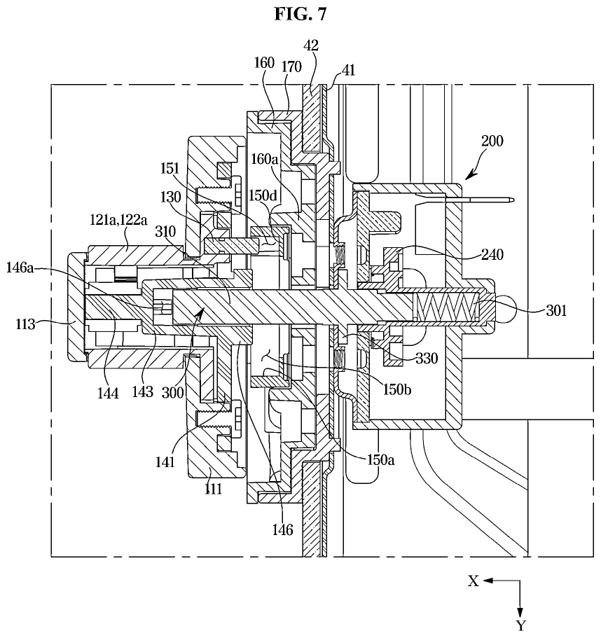

FIG. 4 is an exploded perspective view of the knob assembly in the cooking apparatus according to an embodiment. FIG. 5 is an exploded perspective view of the knob assembly in the cooking apparatus according to an embodiment. In particular, FIG. 4 is the front exploded perspective view of the knob assembly, and FIG. 5 is a rear exploded perspective view of the knob assembly. FIG. 6 is a cross-sectional view of the knob assembly in the cooking apparatus according to an embodiment. In particular, FIG. 6 is the cross-sectional view taken along line B-B′ of the cooking apparatus shown in FIG. 2. FIG. 7 is a cross-sectional view of the knob assembly in the cooking apparatus according to an embodiment. In particular, FIG. 7 is the cross-sectional view taken along line C-C′ of the cooking apparatus shown in FIG. 2.

Referring to FIGS. 4 to 7, the knob assembly 100 according to an embodiment may include a knob 110.

The knob 110 may be graspable by the user. The user may grasp the knob 110 to rotate the knob 110. The knob 110 may be positioned on the front side of the control panel 41. The knob 110 may be exposed to the user.

The knob 110 may be moved in a first direction. For example, the knob 110 may be moved toward the control panel 41. For example, the first direction may be a front-to-back direction.

The knob 110 may be movable between a first knob position and a second knob position. For example, the knob 110 may be prevented from rotating at the first knob position and may be positioned at the second knob position after the knob 110 is moved in the first direction. As will be described later, the knob 110 may be rotated to operate the heat source 90 at the second knob position and a second button position of a button 120. The knob positions may correspond to shaft positions. For example, a shaft 300 may be at a first shaft position while the knob 110 is at the first knob position, and the shaft 300 may be at a second shaft position while the knob 110 is at the second knob position.

The knob 110 may be rotatable relative to the control panel 41. The knob 110 may be rotatable about an axis of a rotation shaft 300, which will be described later. The user may activate the heat source 90 by rotating the knob 110.

The knob 110 may include a base 111, an extension 112, and a handle 113.

The base 111 may form a portion of the knob 110. For example, the base 111 may form a portion of the front, i.e., a perimeter, of the knob 110. The base 111 may include a perimeter portion 111a and a fastening portion 111b.

The perimeter portion 111a may form an outer perimeter of the knob 110. The perimeter portion 111a may be formed in an approximately circular shape. The fastening portion 111b may protrude from the base 111 toward the button 120 and/or a weight 140. For example, the fastening portion 111b may protrude backwardly from the base 111. The knob 110, the button 120, and the weight 140 may be coupled together by a fastener 190, and the fastener 190 may be accommodated in the fastening portion 111b of the knob 110.

The extension 112 may extend from the base 111 toward the user, for example, forwardly. For example, the extension 112 may protrude forwardly from the upper and lower ends of the base 111 during non-rotation. In addition, for example, the extension 112 may protrude forwardly from both ends of the base 111 during rotation. With the extension 112 protruding forwardly, the knob 110 may form a button receiving portion 110a and an opening 110b.

The handle 113 may be disposed at one end of the extension 112. The handle 113 may extend in one direction. For example, in a position before the knob 110 is rotated, the handle 113 may extend along a vertical direction. The user may rotate the knob 110 by gripping the handle 113.

The button receiving portion 110a and the opening 110b may be formed within the knob 110. The button receiving portion 110a may be an internal space formed by the base 111, the extension 112, and the handle 113. The button 120 may be accommodated in the button receiving portion 110a. The button receiving portion 110a may be a button receiving space 110a.

The opening 110b may be formed open through the extension 112 extending from the base 111 and the handle 113. The opening 110b of the knob 110 may be formed on both sides of the knob 110 when the knob 110 is not rotated. For example, the opening 110b may be a side opening 110b. In the opening 110b, pressing portions 121a and 122a of the button 120, which will be described later, may be disposed to allow the user to press and push the button 120.

The knob assembly 100 according to an embodiment may include the button 120. The user may press and push the button 120 to cause the knob 110 to be rotatable. The button 120 may be located between the knob 110 and the control panel 41. For example, the button 120 may be disposed on a rear side of the knob 110 and on a front side of the control panel 41. The button 120 may be coupled to and/or secured to the knob 110 and may rotate together with the knob 110 when the knob 110 rotates.

The button 120 may be moved in a direction different from the first direction. For example, the button 120 may be moved a left-to-right direction. For example, the button may be moved in at least one of a second direction and a third direction. For example, the second and third directions may be perpendicular to the first direction. The button 120 may include a plurality of button portions 121 and 122. The plurality of button portions 121 and 122 may include a first button portion 121 and a second button portion 122. The first button portion 121 and the second button portion 122 may be spaced apart along one direction. For example, the first button portion 121 and the second button portion 122 may be spaced apart in the left-to-right direction. The first button portion 121 may be located on the right side, and the second button portion 122 may be located on the left side. In this case, the button 120 may be before being rotated. However, the plurality of button portions may be formed integrally, so that the button 120 may be formed as a single button portion.

Each of the button portions 121 and 122 may be moved in the second or third direction. For example, a direction in which the first button portion 121 moves toward the second button portion 122 may be the second direction, and a direction in which the second button portion 122 moves toward the first button portion 121 may be the third direction. For example, before the button 120 is rotated, the second direction may be the left direction and the third direction may be the right direction.

The plurality of button portions 121 and 122 may include the pressing portions 121a and 122a, respectively. The pressing portions 121a and 122a may be provided on one side of the button portions 121 and 122. The user may operate the button 120 by pressing and pushing the pressing portions 121a and 122a. For example, the pressing portions 121a and 122a may have a flat shape. For example, the first button portion 121 may include a first pressing portion 121a, and the second button portion 122 may include a second pressing portion 122a.

The plurality of button portions 121 and 122 may include guide portions 121b and 122b, respectively. The guide portions 121b and 122b may guide the movement of the button portions 121 and 122. The guide portions 121b and 122b may be formed by bending one end of the pressing portions 121a and 122a. For example, the guide portions 121b and 122b may extend from a rear end of the pressing portions 121a and 122a in an outward direction. In this case, the outward direction may be opposite to a direction in which receiving portions 121d and 122d are formed. For example, the inward direction may be a direction in which the first button portion 121 faces the second button portion 122 and the second button portion 122 faces the first button portion 121, and the outward direction may be the inward direction. For example, the first guide portion 121b of the first button portion 121 may extend in the third direction (e.g., to the right) from the rear end of the first pressing portion 121a, and the second guide portion 122b of the second button portion 122 may extend in the second direction (e.g., to the left) from the rear end of the second pressing portion 122a. The guide portions 121b and 122b may be referred to as extensions and/or bent portions.

Guide grooves 121e and 122e may be formed in the guide portions 121b and 122b, respectively. For example, the guide grooves 121e and 122e may be formed in a rear side of the guide portions 121b and 122b, and the movement of the button 120 may be guided through guide rails formed in the weight 140 and corresponding to the guide grooves 121e and 122e. The guide grooves 121e and 122e may be recessed from the guide portions 121b and 122b. For example, the first guide portion 121b may include a first guide groove 121e, and the second guide portion 122b may include a second guide groove 122e. The guide grooves 121e and 122e may extend in the second and third directions. For example, when the knob 110 is not rotated, the respective guide grooves 121e and 122e may extend in the left-to-right direction and may be provided in plurality in the vertical direction.

The plurality of button portions 121 and 122 may include racks 121c and 122c, respectively. The racks 121c and 122c may extend from the pressing portions 121a and 122a, respectively. For example, the racks 121c and 122c may extend from the pressing portions 121a and 122a in the inward direction. In this case, the inward direction may be a direction in which the receiving portions 121d and 122d are formed.

For example, the first button portion 121 may include the first rack 121c, and the second button portion 122 may include the second rack 122c. The first rack 121c may extend from the first pressing portion 121a toward the second pressing portion 122a, and the second rack 122c may extend from the second pressing portion 122a to the first pressing portion 121a.

A pinion may be positioned between the first rack 121c and the second rack 122c, and the pinion may rotate between the first rack 121c and the second rack 122c when the button 120 is pressed. As a result, the first button portion 121 and the second button portion 122 may be linearly movable along the first rack 121c, the second rack 122c, and a pinion 124.

For example, when the knob 110 is not rotated, the first rack 121c may be positioned higher than the second rack 122c.

The button 120 may include the pinion 124. The pinion 124 may be positioned between the first rack 121c and the second rack 122c and may be rotatable. The pinion 124 may be mounted on the weight 140. The pinion 124 may be referred to as a gear.

The plurality of button portions 121 and 122 may include the receiving portions 121d and 122d, respectively. The receiving portions 121d and 122d may extend from the pressing portions 121a and 122a. For example, the receiving portions 121d and 122d may extend inwardly from the pressing portions 121a and 122a. Each of the receiving portions 121d and 122d may accommodate a spring 123.

For example, the first receiving portion 121d of the first button portion 121 may extend in the second direction from the first pressing portion 121a toward the second pressing portion 122a. The second receiving portion 122d of the second button portion 122 may extend in the third direction from the second pressing portion 122a toward the first pressing portion 121a. For example, the first button portion 121 and the second button portion 122 may be moved to a position where the first receiving portion 121d and the second receiving portion 122d are in contact.

The springs 123 may be disposed within the plurality of receiving portions 121d and 122d. For example, the plurality of receiving portions 121d and 122d may have a cylindrical shape. For example, the first receiving portion 121d may have a larger diameter than the second receiving portion 122d. The first receiving portion 121d may cover a perimeter (or circumference) of the second receiving portion 122d.

Each of the first receiving portion 121d and the second receiving portion 122d may be provided in a plurality. The plurality of first receiving portions 121d may be arranged to be spaced apart along the vertical direction, and the plurality of second receiving portions may be arranged to be spaced apart from the vertical direction.

The button 120 may include the spring 123. After the plurality of button portions 121 and 122 are pressed and compressed, the spring 123 may compress the first button portion 121 and the second button portion 122 in a direction opposite to the direction in which they were compressed so that they may be returned to their original positions. For example, while pressing the first button portion 121 toward the second button portion 122 and pressing the second button portion 122 toward the first button portion 121 (e.g., from the outside of the buttons to the inside of the buttons), and while the user presses the button portions 121 and 122 after the pressing is completed, and while the pressing is completed, the spring 123 may provide an elastic force to the first button portion 121 and the second button portion 122 in a direction opposite to the pressing direction to cause the first button portion 121 and the second button portion 122 to return to their positions before being pressed.

The springs 123 may be disposed within the plurality of receiving portions 121d and 122d. The springs 123 may also be provided in a plurality. The plurality of springs 123 may be arranged along the vertical direction.

The plurality of button portions 121 and 122 may include position retaining portions 121f and 122f, respectively. The position retaining portions 121f and 122f may contact the fasteners 190 while the button 120 is coupled to the knob 110 and the weight 140 by the fasteners 190 to ensure that the buttons 120 do not move out of position. For example, even if the plurality of springs 123 press the first button portion 121 and the second button portion 122 in an outward direction, the positions of the first button unit 121 and the second button unit 122 may not deviate therefrom due to the fasteners 190 disposed on the position retaining portions 121f and 122f. The first button portion 121 may include the first position retaining portion 121f, and the second button portion 122 may include the second position retaining portion 122f.

The button 120 may include a pin coupling portion 125. The pin coupling portion 125 may be coupled with a locking pin 130 to restrict or allow movement of the knob 110. The pin coupling portion 125 may protrude from the guide portions 121b and 122b toward the weight 140. For example, the pin coupling portion 125 may be formed in the first guide portion 121b. However, the formation position of the pin coupling portion 125 is not limited to the above example and may be formed at various positions, such as being formed in the second guide portion 122b. For example, the pin coupling portion 125 may be formed on the first guide portion 121b and the second guide portion 122b, respectively, so that a plurality of locking pins 130 may be secured to the button 120.

The operational method and configuration of the button 120 are not limited to the above examples. For example, it may be a surge-type structure in which the plurality of button portions 121 and 122 operate simultaneously in response to pressing any one of the plurality of button portions 121 and 122.

The knob assembly 100 according to an embodiment may include the locking pin 130. The locking pin 130 may be coupled, secured, and/or mounted to the button 120. The locking pin 130 may extend along one direction. For example, the locking pin 130 may extend along the front-to-back direction.

The locking pin 130 may prevent and/or allow rotation of the knob 110. For example, the locking pin 130 may be secured to the button 120 such that, while the button 120 is not pressed, the locking pin 130 may prevent rotation of the knob 110 even if the knob 110 and the shaft 300 are pressed backwardly. The locking pin 130 may be referred to as the locking member 130 and the pin 130.

In addition, for example, because the locking pin 130 is secured to the button 120, the locking pin 130 may also move when the button 120 is pressed. For example, the locking pin 130 may move into or out of a stopper groove 151. When the locking pin 130 is moved out of the stopper groove 151 and the knob 110 is moved forward a predetermined distance, the knob 110 may be rotated. In addition, the locking pin 130 may be movable within a guide hole 141a of the weight 140.

While only one locking pin 130 is described in an embodiment, the locking pins 130 may be provided in a plurality. For example, the plurality of locking pins 130 may be coupled to the first guide portion 121b and the second guide portion 122b, respectively, and may be received in the plurality of stopper grooves 151, respectively. Thus, the reliability of the operation of the button 120 may be increased.

The locking pin 130 may be formed of a different material from the button 120. The locking pin 130 may be press-fitted into the stopper groove 151. In addition, the locking pin 130 and the button 120 are formed integrally, and the locking pin 130 may be formed of the same material as the button 120.

For example, the button 120 may be configured as a plastic or a metal, such as aluminum and may be integrally formed therefrom, and the locking pin 130 may be formed from a steel or plastic material.

The knob assembly 100 according to an embodiment may include the weight 140.

The weight 140 may include a base 141. The base 141 may be a part of the weight 140. For example, the base 141 may form a front and a rear of the weight 140. The base 141 may be circular in shape.

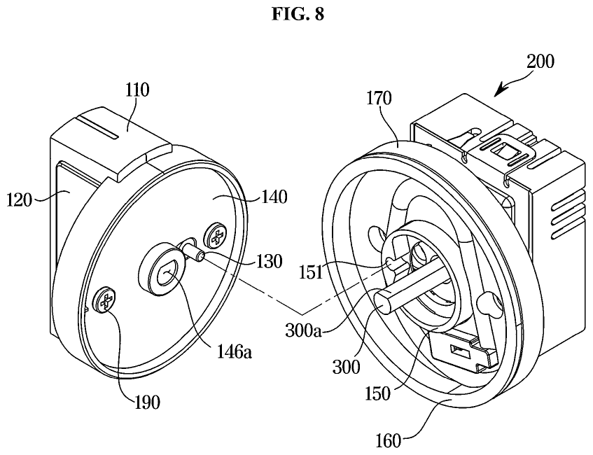

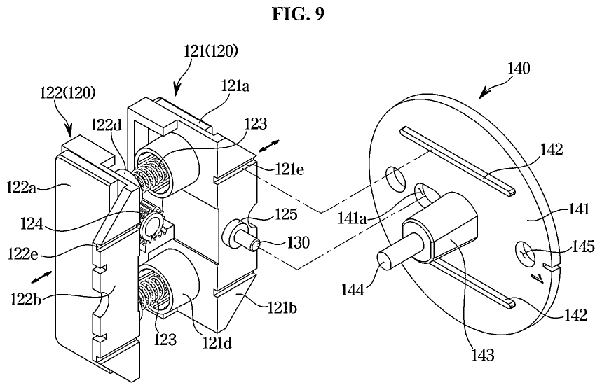

The weight 140 may include a protrusion 143 and a pinion mounting portion 144. The protrusion 143 may protrude from the base 141 toward the button 120. For example, the protrusion 143 may protrude forwardly from the base 141. A portion of a shaft receiving portion 146a may be formed inside the protrusion 143 (see FIGS. 8 and 9).

The pinion mounting portion 144 may protrude from a front end of the protrusion 143. The pinion 124 may be mounted on the pinion mounting portion 144. The pinion mounting portion 144 may have a smaller cross-sectional area than the protrusion 143. The pinion mounting portion 144 may be a gear mounting portion.

The weight 140 may include a rail 142. The rail 142 may be a guide rail 142. The guide rail 142 may be formed to correspond to the guide grooves 121e and 122e of the button 120. The guide rail 142 may be accommodated in the guide grooves 121e and 122e. For example, the movement of the button 120 may be guided through the guide rail 142 of the weight 140 and the guide grooves 121e and 122e of the button 120.

The guide rail 142 may protrude forwardly from the base 141. The guide rail 142 may extend along one direction. For example, when the weight 140 is not rotated, the guide rail 142 may extend along the left-to-right direction. In addition, the guide rails 142 may be provided in a plurality along the vertical direction.

The guide hole 141a may be formed in the weight 140. The guide hole 141a may be formed in the base 141. The locking pin 130 may be movable within the guide hole 141a, and the guide hole 141a may guide the movement of the locking pin 130 to allow the locking pin 130 to move stably along one direction. The guide hole 141a may extend along one direction. For example, the guide hole 141a may extend along the left-to-right direction.

A fastening hole 145 may be formed in the weight 140. The fastening holes 145 may be formed in a plurality in the base 141. The fastener 190 may penetrate the fastening hole 145.

The weight 140 may include a shaft support portion 146. The shaft support portion 146 may accommodate a portion of the shaft 300 therein. A portion of the shaft receiving portion may be formed within the shaft support portion 146 (see FIGS. 8 and 9). The shaft support portion 146 may protrude rearwardly from the base 141.

The weight 140 may be formed by injection molding or pressing. The weight 140 may be configured as a plastic material. However, the formation method and material of the weight 140 are not limited to the above examples.

The weight 140 may be referred to as a mounting member. For example, the weight 140 may be a first mounting member.

The weight 140 may also be omitted when the knob 110, the button 120, and the locking pin 130 are coupled together. In other words, the knob 110, the button 120, and the locking pin 130 may be coupled regardless of the presence or absence of the weight 140, so that the manufacturing process may be simplified and material costs may be reduced, resulting in lower manufacturing costs.

The knob assembly 100 according to an embodiment may include the fastener 190. The fastener 190 may fasten the knob 110, the button 120, and the weight 140. For example, the fastener 190 may couple the knob 110, the button 120, and the weight 140 from a rear side of the weight 140. However, the method of coupling the knob 110, the button 120, and the weight 140 is not limited to the above examples.

The knob assembly 100 according to an embodiment may include a stopper 150. The stopper 150 may be disposed between the weight 140 and a stopper holder 160. For example, the stopper 150 may be disposed behind the weight 140 and in front of the stopper holder 160. The stopper 150 may prevent or allow the knob 110 to rotate. For example, the knob 110 may not be rotated while the locking pin 130 is located in the stopper groove 151, and the knob 110 may be rotated in response to the locking pin 130 being deviated from the stopper groove 151 and the knob 110 being pressed rearwardly.

A hollow portion 150b may be formed in the stopper 150. The hollow portion 150b may be penetrated by the shaft 300 or the like. In addition, the locking pin 130 may be movable within the hollow portion 150b.

The stopper 150 may include a protruding wall 150c that protrudes further inwardly than a perimeter wall 150a. The protruding wall 150c may protrude toward the center and/or hollow portion 150b of the stopper 150.

The stopper 150 may include the stopper groove 151. The stopper groove 151 may be formed in the protruding wall 150c. For example, the stopper groove 151 may be recessed in a direction from the protruding wall 150c toward an outside of the stopper 150. The stopper groove 151 may be formed in a shape corresponding to the locking pin 130. The stopper groove 151 may receive the locking pin 130. For example, the locking pin 130 may be received, arranged, positioned, or inserted within the stopper groove 151. While the locking pin 130 is received in the stopper groove 151, the knob 110 may not be rotated even though the knob 110 and the shaft 300 are pressed rearwardly.

The stopper 150 may include a mounting portion 152. The mounting portion 152 may allow the stopper 150 to be mounted on the stopper holder 160. The mounting portion 152 may protrude rearwardly from a rear wall 150d of the stopper 150. The mounting portion 152 may be inserted into a mounting hole 165 of the stopper holder 160.

The mounting portions 152 may be provided in a plurality. For example, the plurality of mounting portions 152 may be arranged along the vertical direction. For example, the mounting portion 152 may be provided in a hook shape. The mounting portion 152 may be a mounting hook. However, the shape of the mounting portion 152 is not limited to the above example.

The stopper 150 may be formed from plastic or metal. However, the material from which the stopper 150 is formed is not limited to the above examples.

The stopper 150 may be referred to as a mounting member. For example, the stopper 150 may be a third mounting member.

The knob assembly 100 according to an embodiment may include the stopper holder 160. The stopper holder 160 may hold the stopper 150. The stopper 150 may be seated on the stopper holder 160. The stopper holder 160 may include a fixing portion 160a at a central portion, wherein the stopper 150 may be seated, mounted, and/or held on the fixing portion 160a.

The stopper holder 160 may be disposed between the weight 140 and a holder cover 170. For example, the stopper holder 160 may be disposed behind the weight 140 and in front of the holder cover 170.

A light source substrate 161 may be disposed on the stopper holder 160. The light source substrate 161 may control a light source (not shown) disposed on the stopper holder 160. The light source substrate 161 may be disposed adjacent to a fixing portion 160a. For example, the light source substrate 161 may be disposed around the fixing portion 160a.

A diffusion portion 162 may be disposed in the stopper holder 160. The diffusion portion 162 may diffuse light generated by the light source. The diffusion portion 162 may diffuse light outwardly from the knob assembly 100 to indicate that the knob assembly 100 is operating. The diffusion portion 162 may be disposed around the fixing portion 160a. The diffusion unit 162 may be referred to as a diffusion member or a light diffusion portion.

The fastening holes 145 may be formed in the stopper holder 160. The fastener through the fastening holes 145 may allow the stopper holder 160 to be coupled to a reinforcement plate 42 and the control panel 41.

The stopper holder 160 may include a hook 164. The hook 164 may protrude rearwardly to couple the stopper holder 160 to the holder cover 170. For example, the hook 164 may be inserted into a hook hole 173 of the holder cover 170.

The mounting hole 165 may be formed in the stopper holder 160. The mounting portion 152 of the stopper 150 may be inserted into the mounting hole 165. The mounting hole 165 may be formed to correspond to the mounting portion 152. The mounting holes 165 may be provided in a plurality.

The stopper holder 160 may be referred to as a mounting member. For example, the stopper holder 160 may be a second mounting member.

The knob assembly 100 according to an embodiment may include the holder cover 170. The holder cover 170 may cover the perimeter of the stopper holder 160. In addition, the holder cover 170 may fill a gap between the reinforcement plate 42 or the control panel 41 and the stopper holder 160. The holder cover 170 may be disposed between the stopper holder 160 and the reinforcement plate 42 or the control panel 41.

A perimeter 171 of the holder cover 170 may cover the perimeter of the stopper holder 160. The hook 164 of the stopper holder 160 may be inserted into a hook hole 172 of the holder cover 170. The hook hole 172 may be formed to correspond to the hook 164. A mounting pin 173 may be formed on a rear side of the holder cover 170. The mounting pin 173 may be inserted into a mounting hole 41c provided in the control panel 41 to secure the holder cover 170 to the control panel 41. The mounting pins 173 may be provided in a plurality. For example, the plurality of mounting pins 173 may be arranged along the left-to-right direction.

The holder cover 170 may be referred to as a mounting member. For example, the holder cover 170 may be a fourth mounting member. In addition, the holder cover 170 may be a mounting member cover.

In an embodiment, the weight 140, the stopper 150, the stopper holder 160, and the holder cover 170 have each been described, but the present disclosure is not limited thereto and the weight 140, the stopper 150, the stopper holder 160, and the holder cover 170 may be formed integrally. For example, the plurality of mounting members may be formed as a single mounting member.

The cooking apparatus may include the reinforcement plate 42. The reinforcement plate 42 may be disposed between the control panel 41 and the holder cover 170 to increase the rigidity of the cooking apparatus. A hole 42a into which the holder cover 170 may be inserted may be formed in the reinforcement plate 42. The holder cover 170 may be disposed within the hole 42a. The reinforcement plate 42 may be glass. However, the reinforcement plate 42 may be omitted.

The control panel 41 may include a plurality of holes 41a, 41b, and 41c, and the shaft 300 may pass through the first hole 41a. The fastener for mounting the stopper holder 160 to the control panel 41 may pass through the second hole 41b. The fastener passing through the second hole 41b may penetrate a regulator 200, and thus the stopper holder 160, the control panel 41, and the regulator 200 may be coupled. The mounting pin 173 of the holder cover 170 may be inserted into the third hole 41c.

The cooking apparatus 1 may further include the regulator 200. The regulator 200 may be disposed on a rear side of the control panel 41. The regulator 200 may operate the heat source in response to the rotation of the knob 110. The regulator 200 may be configured to be included in the knob assembly 100.

FIG. 8 is a perspective view showing a coupling of some configuration of the knob assembly in the cooking apparatus according to an embodiment.

Referring to FIG. 8, in the knob assembly 100 according to an embodiment, the knob 110, the button 120, the locking pin 130, and the weight 140 may be coupled. For example, the fastener 190 may fasten the knob 110, the button 120, the locking pin 130, and the weight 140. However, the method of coupling the knob 110, the button 120, the locking pin 130, and the weight 140 is not limited to the above examples.

In the knob assembly 100 according to an embodiment, the stopper 150, the stopper holder 160, and the holder cover 170 may be coupled. For example, the stopper 150, the stopper holder 160, and the holder cover 170 may be coupled by the hook 164 and a screw. However, the method of coupling the stopper 150, the stopper holder 160, and the holder cover 170 is not limited to the above examples.

The locking pin 130 and the stopper groove 151 may correspond to each other. The locking pin 130 may be accommodated in the stopper groove 151 or may be separated from the stopper groove 151. For example, while the button 120 is not pressed, the locking pin 130 may be disposed within the stopper groove 151, and the knob 110 may be prevented from rotating. In addition, for example, the locking pin 130 leaves the stopper groove 151 in response to the button 120 being pressed, and thus the knob 110 may be allowed to rotate.

The shaft 300 may be secured to the weight 140. For example, the shaft receiving portion and the shaft 300 may be formed correspondingly, and thus the shaft 300 may be inserted into and secured to the weight 140. For example, the shaft 300 may include a plane 300a, and the shaft receiving portion may have a corresponding shape, so that the shaft 300 may be secured to the weight 140.

The shaft 300 may secured to the weight 140 and may rotate together with the rotation of the knob 110 in response to the rotation of the knob 110. For example, since the knob 110, the button 120, and the weight 140 are secured by the fastener 190, the shaft 300 may rotate with the knob 110.

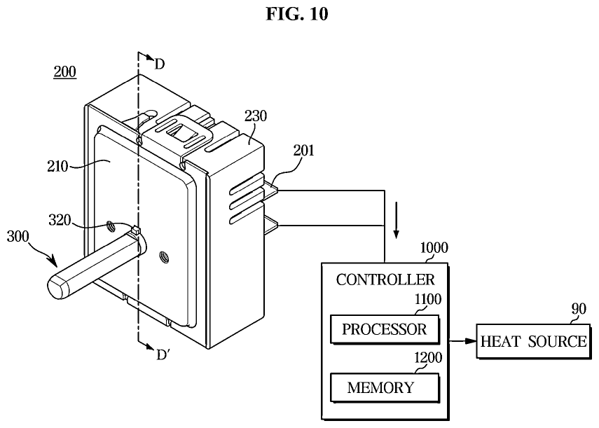

When the button 120 is pressed laterally to cause the locking pin 130 to exit the stopper groove 151, and the knob 110 is pressed rearwardly to cause a fixing protrusion 320 of the shaft 300 to exit a fixing groove 211a, thereby causing a cam 240 to electrically connect a plurality of terminals 201, the regulator 200 may transmit an electrical signal to a processor 1100 to operate the heat source 90 (FIGS. 10 to 13).

FIG. 9 is a perspective view showing a coupling of some configuration of the knob assembly in the cooking apparatus according to an embodiment.

Referring to FIG. 9, the first button portion 121 and the second button portion 122 may be moved in one direction when they are pressed by the user. For example, the first button portion 121 and the second button portion 122 may be moved along the left-to-right direction.

While the first button portion 121 and the second button portion 122 are pressed, the first button portion 121 may move toward the second button portion 122 and the second button portion 122 may move toward the first button portion 122. While the first button portion 121 and the second button portion 122 are not pressed, the first button portion 121 may move away from the second button portion 122 and the second button unit 122 may move away from the first button portion 121 due to the spring 123 disposed between the first button portion 121 and the second button portion 122.

The button may be guided in linear movement by the weight 140. The button 120 may be slidably moved relative to weight 140. For example, the guide grooves 121e and 122e recessed forwardly may be formed in the guide portions 121b and 122b of the button 120, and the guide rails 142 protruding forwardly from the base 141 may be formed on the weight 140. Alternatively, the guide rails 142 may be formed to protrude rearwardly from the guide portions 121b and 122b of the button 120, and the guide grooves 121e and 122e may be formed to recess rearwardly from the base 141 of the weight 140. In addition, the guide rails 142 may be formed on the knob 110. The guide grooves 121e and 122e and the guide rails 142 may be formed to correspond to each other.

Even though the user presses an upper or lower portion of the pressing portions 121a and 122a instead of the central portion of the pressing portions 121a and 122a or the entire pressing portions 121a and 122a, the guide grooves 121e and 122e and the guide rails 142 may allow the button 120 to be stably moved linearly by the guide rails 142. For example, even if the user presses the upper portion or the lower portion of the pressing portions 121a and 122a, the guide grooves 121e and 122e and the guide rails 142 may minimize the wobbling of the button 120, and may prevent the button portions 121 and 122 from tilting upwardly or downwardly.

While the button 120 is moved linearly with respect to the weight 140, the locking pin 130 may be moved within the guide hole 141a. The guide hole 141a may guide the movement of the locking pin 130. The guide hole 141a may extend along one direction. For example, the guide hole 141a may extend along the left-to-right direction. The guide hole 141a may be formed at a position corresponding to the locking pin 130.

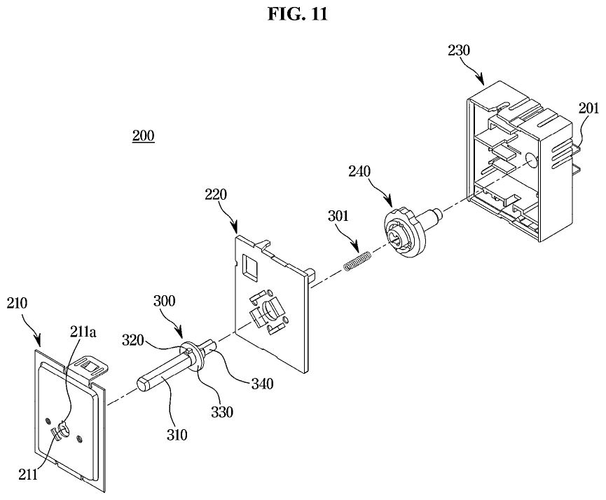

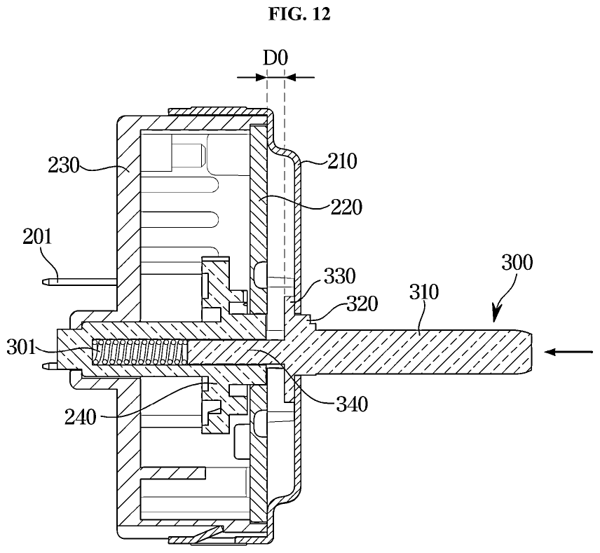

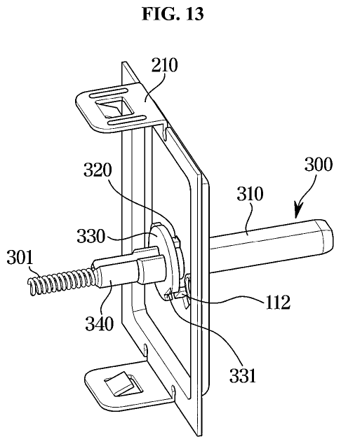

FIG. 10 is a perspective view showing the regulator in the cooking apparatus according to an embodiment. FIG. 11 is an exploded perspective view showing the regulator in the cooking apparatus according to an embodiment. FIG. 12 is a cross-sectional view showing the regulator in the cooking apparatus according to an embodiment. In particular, FIG. 12 is the cross-sectional view of the regulator taken along line D-D′ in FIG. 10. FIG. 13 is a perspective view showing a partial configuration of the regulator in the cooking apparatus according to an embodiment.

FIGS. 10 to 13 shows a process by which the heat source 90 is controlled as the knob 110 is rotated in the cooking apparatus according to an embodiment.

Referring to FIGS. 10 to 13, the cooking apparatus 1 according to an embodiment may include a controller 1000. The controller 1000 may include a processor 1100 and a memory 1200.

The processor 1100 may include a program (a plurality of instructions) for processing signals and providing control signals.

The memory 1200 may include volatile memories, such as static random access memory (S-RAM), dynamic random access memory (D-RAM), and the like, and non-volatile memories, such as read only memory (ROM), erasable programmable read only memory (EPROM), and the like.

The memory 1200 may be provided integrally with the processor 1100 or may be provided as a semiconductor device separate from the processor 1100.

The processor 1100 may further include a processing core (e.g., memory circuitry and control circuitry) that processes signals based on programs or data stored in the memory 1200 and outputs control signals.

The regulator 200 may include a plurality of terminals 201, and when the plurality of terminals 201 are in contact with each other, the regulator 200 may generate a signal for the processor 1100 to receive.

The processor 1100 may control the heat source 90 to cause the heat source 90 to operate based on user input detected by the regulator 200. For example, rotation of the knob 110 may cause rotation of the shaft 300, which may cause rotation of the cam 240 by the shaft 300, which may cause the cam 240 to electrically connect the plurality of terminals 201 of the regulator 200 to each other, and subsequently the regulator 200 may generate a signal. The processor 1100 may turn on the heat source 90 based on a signal generated by the regulator 200.

However, in order for the shaft 300 to rotate to cause the cam 240 to rotate, the shaft 300 may be at the second shaft position. This is because, when the shaft 300 is at the first shaft position, the fixing protrusion 320 is received in the fixing groove 211a, thereby restricting the rotation of the shaft 300. Accordingly, the shaft 300 may need be moved from the first shaft position to the second shaft position in order for the regulator 200 to operate. The shaft position may correspond to the knob position. For example, the first shaft position may correspond to the first knob position, and the second shaft position may correspond to the second knob position.

The cooking apparatus 1 may include the regulator 200. The regulator 200 may include cases 210, 220, and 230. The cases 210, 220, and 230 may be provided in a plurality. The plurality of cases 210, 220, and 230 may form the exterior of the regulator 200.

The plurality of cases 210, 220, and 230 may include the first case 210, the second case 220, and the third case 230.

The first case 210 may be disposed on a front side of the second and third cases. The first case may be coupled to the third case to form a space inside the case. The first case 210 may form one side of the regulator 200.

The first case 210 may cover the second case 220. The first case 210 may be configured to correspond to the second case 220.

A shaft hole 211 may be formed in the first case 210. The shaft 300 may pass through the shaft hole 211.

The shaft hole 211 may have a shape corresponding to the shaft 300 to allow the shaft 300 to pass therethrough. For example, if the shaft 300 has a circular cross-section, the shaft hole 211 may also have a cylindrical shape. In addition, for example, the shaft hole 211 may have a column shape with a diameter similar to the cross-sectional shape of the shaft 300.

The fixing groove 211a may be formed in the first case 210. The fixing protrusion 320 of the shaft 300 may be inserted into the fixing groove 211a. The fixing groove 211a may be located in the first case 210.

The fixing groove 211a may be recessed in one direction from the shaft hole 211. The fixing groove 211a may be recessed in the shaft hole 211 in the radial direction.

The fixing groove 211a may have a shape corresponding to the fixing protrusion 320. The fixing protrusion 320 may be accommodated in the fixing groove 211a. While the fixing protrusion 320 is accommodated in the fixing groove 211a, the movement of the fixing protrusion 320 may be restricted, thereby preventing the rotation of the shaft 300. In this case, the shaft 300 may be at the first shaft position.

However, the present disclosure is not limited to the above examples, and the fixing protrusion 320 may be positioned on the first case 210 and the fixing groove 211a may be positioned on the shaft 300.

The second case 220 may be positioned forwardly of the third case 230. The second case 220 may be disposed between the first case and the third case. The second case may be positioned in an inner space formed by the first case and the third case. The second case 220 may have the shape of a flat plate with a predetermined thickness. However, the shape and thickness of the second case 220 are not limited to the above examples.

When the cases 210, 220, and 230 have the shape of a cuboid, the third case 230 may be configured to define five sides of the cuboid.

The regulator 200 may include the shaft 300. The shaft 300 may be rotatable with respect to the cases 210, 220, and 230. The shaft 300 may extend in one direction. For example, the shaft 300 may extend along the front-to-back direction. In addition, for example, the shaft 300 may be approximately cylindrical in cross-section.

The shaft 300 may penetrate the first case 210. The shaft 300 may be movable within the cases 210, 220, and 230 along the direction in which the shaft 300 extends.

The shaft 300 may include a shaft body 310. The shaft body 310 may extend along one direction. For example, the shaft body 310 may extend along the front-to-back direction. The shaft body 310 may be at least partially inserted within the cases 21, 220, and 230.

As the knob 110 is moved and pressed, the shaft body 310 may also be moved and pressed. For example, in response to the knob 110 and the shaft body 310 being moved by a predetermined distance DO, the cam 240 may electrically connect the terminals 201 within the cases 210, 220, and 230, so that the regulator 200 may generate an electrical signal and transmit the signal to the processor 1100.

The shaft 300 may include the fixing protrusion 320. The fixing protrusion 320 may prevent the rotation of the shaft 300. The fixing protrusion 320 may protrude from the shaft body 310 along the radial direction. The fixing protrusion 320 may be accommodated in the fixing groove 211a. While the fixing protrusion 320 is accommodated in the fixing groove 211a, the fixing protrusion 320 may contact the first case 210, thereby restricting the rotation of the shaft 300.

The fixing protrusion 320 may have a shape corresponding to the fixing groove 211a. The fixing protrusion 320 may have a shape similar to the fixing groove 211a.

The fixing protrusion 320 may protrude from the shaft body 310 to be received in the fixing groove 211a when the shaft 300 is at the first shaft position. The fixing protrusion 320 may exit from the fixing groove 211a when the shaft 300 is at the second shaft position.

The shaft 300 may include a shaft flange 330. The shaft flange 330 may be configured to contact the second case 220 or the first case 210 when the shaft 300 moves forward and backward.

The shaft flange 330 may protrude from the shaft body 310 in the radial direction. The shaft flange 330 may extend from the shaft body 310 in a circumferential direction.

The shaft 300 may be prevented from exiting forwardly by the cases 210, 220, and 230. For example, when the shaft 300 moves forward, the shaft flange 330 contacts the first case 210 to prevent the shaft 300 from deviating forward.

The shaft flange 330 may have a groove stopper 331. The groove stopper 331 may prevent the shaft 300 from rotating when the shaft 300 is at the first shaft position.

The groove stopper 331 may be positioned on the shaft flange 330. The groove stopper 331 may be recessed from an outer diameter of the shaft flange 330 toward the axis of rotation of the shaft 300.

The groove stopper 331 may accommodate a groove stopper locking portion 212. The groove stopper locking portion 212 may be included in the first case 210. The groove stopper locking portion 212 may protrude rearwardly. The groove stopper locking portion 212 may protrude toward the second case 220. The groove stopper locking portion 212 may have a shape corresponding to the groove stopper 331.

The groove stopper locking portion 212 may be accommodated in the groove stopper 331 when the shaft 300 is at the first shaft position. Accordingly, based on the shaft 300 being at the first shaft position, when the shaft 300 is attempted to rotate, the groove stopper locking portion 212 may contact the shaft flange 330 to restrict the rotation of the shaft 300.

The groove stopper locking portion 212 may be deviated from the groove stopper 331 based on the shaft 300 being at the second shaft position. Accordingly, based on the shaft 300 being at the second shaft position, when the shaft 300 is rotated, the groove stopper locking portion 212 may make a rotational movement since there is no contact structure.

The shaft 300 may be prevented from deviating rearwardly by the cases 210, 220, and 230. For example, when the shaft 300 moves rearwardly, the shaft flange 330 may contact the second case 220 to prevent the shaft 300 from deviating rearwardly.

As a result, the shaft flange 330 may prevent the shaft 300 from deviating from the cases 210, 220, and 230.

The shaft 300 may be positioned at the first shaft position. When the shaft 300 is positioned at the first shaft position, the fixing protrusion 320 may be accommodated in the fixing groove 211a. For example, the fixing protrusion 320 may protrude from the shaft body 310 to be received in the fixing groove 211a when the shaft 300 is positioned at the first shaft position.

The shaft 300 may be positioned at a second shaft position. When the shaft 300 is positioned at the second shaft position, the fixing protrusion 320 may be spaced apart from the fixing groove 211a by an operating distance.

While the shaft 300 is at the second shaft position, the cam 240 may rotate with the shaft 300, thereby enabling the regulator 200 to detect user input. The cam 240 may be adjacent to the shaft 300 such that the shaft 300 is inserted.

The shaft 300 may include an anti-rotation protrusion 340. The anti-rotation protrusion 340 may be configured to rotate together with the cam 240 while being accommodated in the cam 240. For example, the anti-rotation protrusion 340 may be formed to correspond to the cam 240, so that the cam 240 may rotate together without spinning as the shaft 300 rotates.

The regulator 200 may include the cam 240. The cam 240 may be configured to receive a rotational force from the shaft 300. The cam 240 may rotate together with the shaft 300. The cam 240 may be configured to be rotatable in the third case 230. Accordingly, the cam 240 may be rotatable while being supported by the third case 230.

The regulator 200 may include the terminals 201. The terminals 201 may be configured to allow electricity to flow. While the plurality of terminals 201 are electrically connected to each other, the regulator 200 may generate a signal based on user input.

The cam 240 may allow the plurality of terminals disposed within the cases 210, 220, and 230 to contact, and when the plurality of terminals are contacted, the regulator 200 may output a signal corresponding to the user input.

The regulator 200 may include a shaft elastic member 301. The shaft elastic member 301 may be configured to press the shaft 300 forward. The shaft elastic member 301 may be positioned between the shaft 300 and the cam 240.

The shaft elastic member 301 may be a configuration that presses the shaft 300 to allow the fixing protrusion 320 to be positioned in the fixing groove 211a. The shaft elastic member 301 may press against the anti-rotation protrusion 340. The shaft elastic member 301 may be in contact with the anti-rotation protrusion 340. The shaft elastic member 301 may be compressed by the shaft 300, thereby pressing the shaft 300 in a direction opposite to the compression.

The user may generate a signal from the regulator 200 by pressing and rotating the shaft 300. When the user wishes to stop generating a signal from the regulator 200, the user may release the pressure on the shaft 300 to return the shaft 300 to its original position.

In an example, the shaft elastic member 301 may include a compression spring.

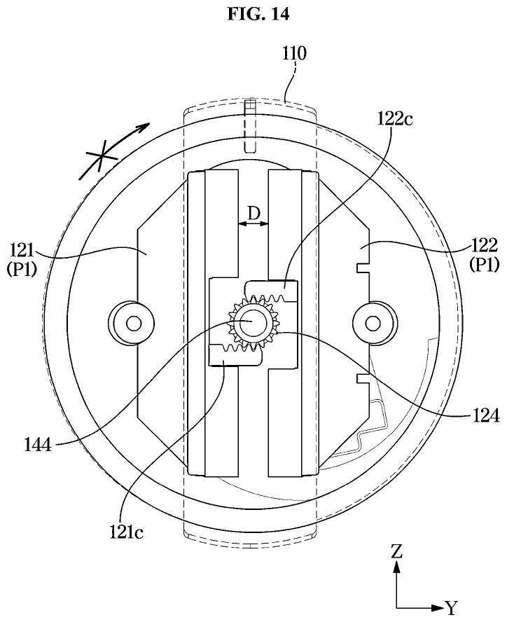

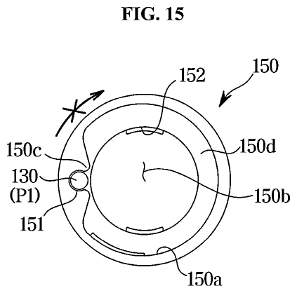

FIG. 14 is a schematic view showing a partial configuration of the cooking apparatus according to an embodiment. FIG. 15 is a schematic view showing a partial configuration of the cooking apparatus according to an embodiment. In particular, FIG. 14 is a front view of the knob and the buttons as seen from the front of the cooking apparatus according to an embodiment, and FIG. 15 is a front view of the stopper as seen from the front of the cooking apparatus according to an embodiment.

Referring to FIGS. 14 and 15, in the cooking apparatus according to an embodiment, the knob 110 may not be rotated before the button 120 is moved linearly. For example, the knob 110, the button 120, and the locking pin 130 are coupled, and even if an attempt is made to rotate the knob 110, the rotation of the locking pin 130 may be restricted by the walls 150a and 150c of the stopper 150, so that the locking pin 130 may not rotate in the stopper groove 151. In this case, while the button 120 is not moved or pressed, the button 120 may be positioned at the first button position P1. For example, while the button portions 121 and 122 are not moved or pressed, the button portions 121 and 122 may be positioned at the first button position P1. For example, at the first button position P1, the first button portion 121 and the second button portion 122 may have a predetermined distance D1. In addition, while the button 120 is not moved or pressed, the locking pin 130 may also be positioned at a first pin position P1. For example, while the button portions 121 and 122 are not moved or pressed, the locking pin 130 may be positioned at the first pin position P1. The button positions and pin positions may correspond. For example, the pin 130 may be at the first pin position P1 while the button 120 is at the first button position P1, and the pin 130 may be at a second pin position P2 while the button 120 is at the second button position P2.

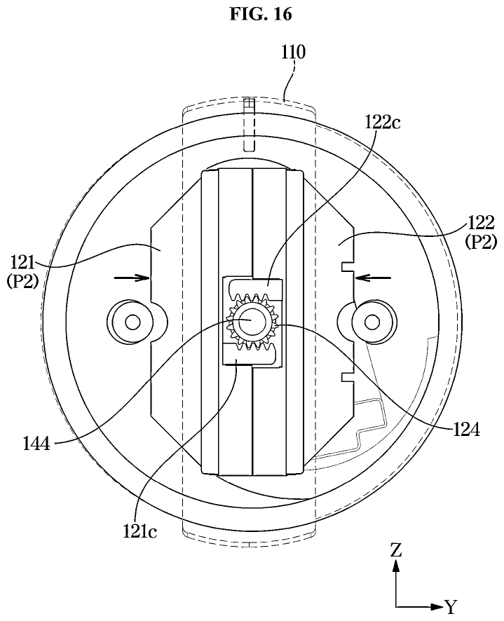

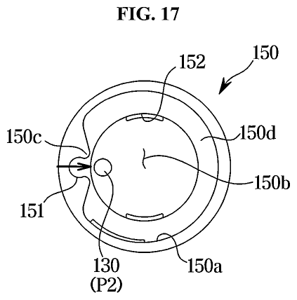

FIG. 16 is a schematic view showing a partial configuration of the cooking apparatus according to an embodiment. FIG. 17 is a schematic view showing a partial configuration of the cooking apparatus according to an embodiment. In particular, FIG. 16 is a front view of the knob and the buttons as seen from the front of the cooking apparatus according to an embodiment, and FIG. 17 is a front view of the stopper as seen from the front of the cooking apparatus according to an embodiment.

Referring to FIGS. 16 and 17, in the cooking apparatus according to an embodiment, the button 120 may be moved from the first button position P1 to the second button position P2 as it is pressed by the user. For example, the button portions 121 and 122 may be moved from the first button position P1 to the second button position P2 as they are pressed by the user. The second button position P2 of the button portions 121 and 122 may be a position where the first button portion 121 and the second button portion 122 are closer to each other than at the first button position P1. For example, at the second button position P2, the first button portion 121 and the second button portion 122 may be in contact, or the first receiving portion 121d and the second receiving portion 122d may be in contact. In addition, the locking pin 130 may also be moved from the first button position P1 to the second button position P2 as the button 120 is pressed by the user. The second button position P2 of the locking pin 130 may be separated from or deviated from the stopper groove 151. For example, at the second button position P2, the locking pin 130 may be positioned on the hollow portion 150b (or receiving space) of the stopper 150.

The first button portion 121 and the second button portion 122 may be moved linearly from the first button position P1 to the second button position P2 through the respective racks 121c and 122c and the pinion 124. As the first button portion 121 and the second button portion 122 are linearly moved, the locking pin 130 secured to the first button portion 121 may also be moved linearly from the first button position P1 to the second button position P2. The locking pin 130 that has been linearly moved may be moved and deviated from the stopper groove 151. As the locking pin 130 is moved and deviated from the stopper groove 151, the knob 110 may become rotatable.

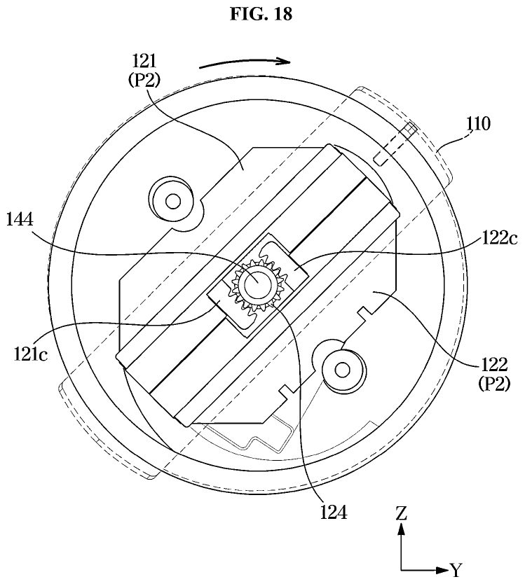

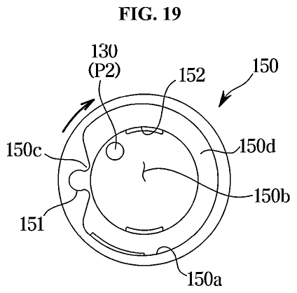

FIG. 18 is a schematic view showing a partial configuration of the cooking apparatus according to an embodiment. FIG. 19 is a schematic view showing a partial configuration of the cooking apparatus according to an embodiment. In particular, FIG. 18 is a front view of the knob and the button as seen from the front of the cooking apparatus according to an embodiment, and FIG. 19 is a front view of the stopper as seen from the front of the cooking apparatus according to an embodiment.

Referring to FIGS. 18 and 19, in the cooking apparatus according to an embodiment, the knob 110 may be rotated at the second position P2 of the button 120 and the locking pin 130. As the locking pin 130 is moved and deviated from the stopper groove 151, the knob 110 may be in a rotatable state. For example, the user may rotate the knob 110 in one direction while moving the knob 110 to the second position toward the control panel 41 and moving the button 120 to the second button position P2. For example, the knob 110 may be rotated clockwise when as viewed from the front of the cooking apparatus.

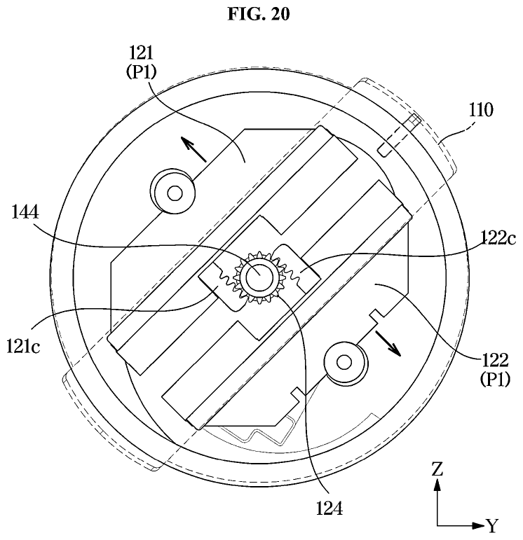

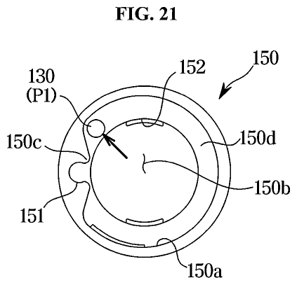

FIG. 20 is a schematic view showing a partial configuration of the cooking apparatus according to an embodiment. FIG. 21 is a schematic view showing a partial configuration of the cooking apparatus according to an embodiment. In particular, FIG. 20 is a front view of the knob and the button as seen from the front of the cooking apparatus according to an embodiment, and FIG. 21 is a front view of the stopper as seen from the front of the cooking apparatus according to an embodiment.

Referring to FIGS. 20 and 21, in the cooking apparatus according to an embodiment, the button 120 and the locking pin 130 may be moved from the second position P2 to the first position P1 as the pressure from the user is removed. For example, the button portions 121 and 122 and the locking pin 130 may be moved from the second position P2 to the first position P1 as the press from the user is removed.

The first button portion 121 and the second button portion 122 are linearly moved from the second button position P2 to the first button position P1 through the respective racks 121c and 122c and the pinion 124. As the first button portion 121 and the second button portion 122 are moved linearly, the locking pin 130 secured to the first button portion 121 may also be linearly moved from the second pin position P2 to the first pin position P1. As the locking pin 130 is moved linearly, it may be disposed adjacent to the perimeter wall 150a of the stopper 150. However, at this time, the locking pin 130 may be spaced apart by a predetermined distance without contacting the perimeter wall 150a of the stopper 150. Accordingly, even if the knob 110 is rotated without the button 120 being pressed, friction and damage caused by the locking pin 130 and the perimeter wall 150a of the stopper 150 contacting each other may be prevented. Since friction and damage to the locking pin 130 and the stopper 150 are prevented, the service life of the locking pin 130 and the stopper 150 may be extended.

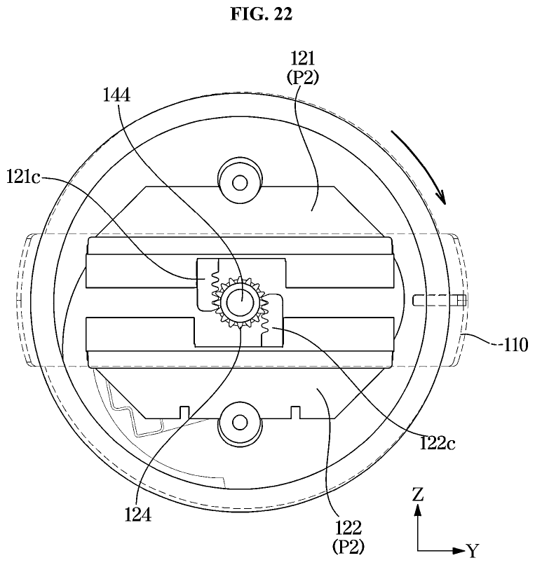

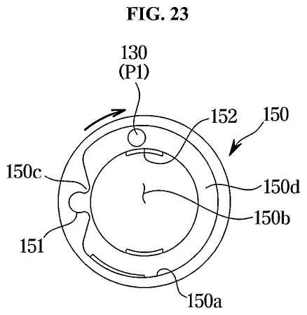

FIG. 22 is a schematic view showing a partial configuration of the cooking apparatus according to an embodiment. FIG. 23 is a schematic view showing a partial configuration of the cooking apparatus according to an embodiment.

Referring to FIGS. 22 and 23, in the cooking apparatus according to an embodiment, the knob 110 may rotate continuously at the first position P1 of the button 120 and the locking pin 130. In this case, even though the knob 110 is rotated, the locking pin 130 may be spaced a predetermined distance away from the perimeter wall 150a of the stopper 150 without contacting the perimeter wall 150a of the stopper 150, and damage caused by the locking pin 130 and the perimeter walls 150a of the stopper 150 contacting each other may be prevented. Since friction and damage to the locking pin 130 and the stopper 150 are prevented, the service life of the locking pin 130 and the stopper 150 may be extended.

Then, the user may turn the knob 110 counterclockwise from the front of the cooking apparatus as seen from the front to switch off the heat source. At this point, even if the user does not press the button 120 separately, the locking pin 130 may be guided by the slope formed on the protruding wall 150c and inserted back into the stopper groove 151.

Through the process of FIGS. 14 to 23, it is required to move the knob 110 toward the control panel 41 side and to move the button 120 and the locking pin 130 from the first position P1 to the second position P2 so that the knob 110 may be rotated. Accordingly, since two moving mechanisms are required to rotate the knob 110, malfunction of the knob 110 may be prevented. Since malfunction of the knob 110 is prevented, the heat source may be prevented from operating when not intended by the user, thereby reducing the risk of burns to the user and the risk of fire.

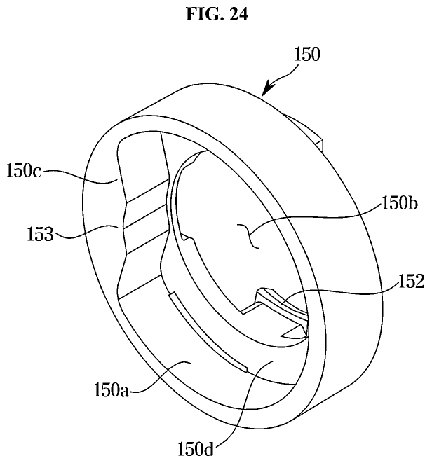

FIG. 24 is a perspective view showing the stopper in the cooking apparatus according to an embodiment.

Referring to FIG. 24, in the cooking apparatus according to an embodiment, the stopper 150 may include an anti-movement portion 153. The anti-movement portion 153 may protrude from the perimeter wall 150a of the stopper 150 inwardly of the stopper 150.

The anti-movement portion 153 may be in contact with the locking pin 130. For example, when the user presses the knob 110 toward the control panel 41 without pressing the button 120, the locking pin 130 may contact the anti-movement portion 153. In this case, a distance between the locking pin 130 and the anti-movement portion 153 may be shorter than the length of the fixing protrusion 320 of the shaft 300. For example, since the distance between the locking pin 130 and the anti-movement portion 153 is shorter than the length of the fixing protrusion 320 of the shaft 300, the locking pin 130 and the anti-movement portion 153 may contact each other before the fixing protrusion 320 deviates from the fixing groove 211a and the shaft 300 reaches the second shaft position in which the shaft 300 is rotatable. The anti-movement portion 153 may be a support.

While the user presses the button 120, the locking pin 130 may be moved toward the hollow portion 150b of the stopper 150, and thus the locking pin 130 may not contact the anti-movement portion 153 even when the knob 110 is pressed toward the control panel 41. Since the locking pin 130 does not contact the anti-movement portion 153, the fixing protrusion 320 may move out of the fixing groove 211a and the shaft 300 may reach the rotatable second shaft position.

According to an embodiment, it is required to move the knob 110 toward the control panel 41 and to move the button 120 and the locking pin 130 from the first position P1 to the second position P2 so as to allow the knob 110 to be rotated. Accordingly, since two moving mechanisms are required to rotate the knob 110, malfunction of the knob 110 may be prevented. Since malfunction of the knob 110 is prevented, the heat source may be prevented from operating when not intended by the user, thereby reducing the risk of burns to the user and the risk of fire.

In this case, for example, the locking pin 130 according to an embodiment may be shorter in length than the locking pin 130 described in FIGS. 4 to 9.

According to various embodiments of the present disclosure, the cooking apparatus may be provided in which malfunction of the knob may be prevented because the movement of the knob and the button causes the knob to be rotated to turn on the heat source.

Further, according to various embodiments of the present disclosure, the cooking apparatus is provided in which malfunction of the knob may be prevented, thereby preventing fires and burns caused by malfunction of the knob.

Further, according to various embodiments of the present disclosure, the cooking apparatus may be provided in which the contact between the stopper and the locking pin may be minimized, so that damage to the stopper and the locking pin may be minimized and the durability may be increased.

The effects of various embodiments of the present disclosure are not limited to those mentioned above, and other effects not mentioned will be apparent to those skilled in the art from the following description.

The cooking apparatus according to an embodiment may include the housing 10, the heat source 90 provided on one side of the housing, the control panel 41 coupled to the housing, and the knob 110 rotatably mounted on the control panel so as to operate the heat source and movable rearwardly, the stopper 150 disposed between the control panel and the knob and including the anti-rotation portion 151 configured to prevent rotation of the knob 150, the button 120 movably coupled to the knob in the left-to-right direction, and the locking pin 130 accommodated in the anti-rotation portion and secured to the button so as to move along the button, wherein the locking pin is deviated from the anti-rotation portion based on movement of the button, the knob is rotatable while the knob is moved rearwardly and the locking pin is deviated from the anti-rotation portion, and the knob is rotated to operate the heat source.

The rotation of the knob is prevented while the locking pin is accommodated in the anti-rotation portion.

The locking pin 130 may be movable between the first pin position P1 in which the rotation of the knob is locked by being accommodated in the anti-rotation portion and the second pin position P2 in which the rotation of the knob is unlocked by being deviated from the anti-rotation portion, and the anti-rotation portion may include the stopper groove 151 in which the locking pin is accommodated at the first pin position of the locking pin, and while the button is moved in the left-to-right direction, the locking pin may be moved from the first pin position to the second pin position to allow the locking pin to be deviated from the stopper groove.

The button may be configured to rotate along the knob at the second pin position of the locking pin, and after the knob and the button are rotated at a predetermined angle, the locking pin may be movable to the first pin position.

The knob and the button may be rotatable while the locking pin is at the first pin position after the knob and the button are rotated at the predetermined angle.

The stopper 150 may include the hollow portion 150b, the perimeter wall 150a forming the hollow portion, the protruding wall 150c protruding from the perimeter wall 150a and on which the stopper groove is formed.

The button 120 may include the first pressing portion 121a and the second pressing portion 122a arranged in one direction, the first rack 121c extending from the first pressing portion toward the second pressing portion, the second rack 122c extending from the second pressing portion toward the first pressing portion, and the pinion 124 disposed between the first rack and the second rack so as to be rotatable in response to the first pressing portion and the second pressing portion being pressed.

The button 120 may further include the spring 123 disposed between the first pressing portion and the second pressing portion to press the first pressing portion and the second pressing portion.

The control panel may be disposed on a front side of the housing, and the button 120 may further include the first guide portion 121b extending in left-to-right direction from a rear end of the first pressing portion, the second guide portion 122b extending in left-to-right direction from a rear end of the second pressing portion; and the guide grooves 121e and 122e formed in the first guide portion and the second guide portion in the left-to-right direction to guide the movement of the first pressing portion and the second pressing portion.

The cooking apparatus may further include the weight 140 disposed on a front side of the stopper, wherein the weight may include the base 141, and the guide rail 142 protruding from the base toward the button and arranged in in the left-to-right direction so as to be inserted into the guide groove.

The knob 110 may include the receiving space 110a configured to receive the button, and the first pressing portion and the second pressing portion may be exposed from the receiving space to be pressed.

The cooking apparatus may further include the weight 140 disposed on a front side of the stopper, wherein the weight may include the base 141, the pinion mounting portion 144 protruding from the base to allow the pinion to be mounted, and the guide hole 141a formed in the base to guide the movement of the locking pin.

The cooking apparatus may further include the stopper holder 160 coupled to the control panel to secure the stopper, wherein the stopper holder 160 may include the fixing portion 160a to which the stopper is secured, the light source substrate 161 disposed outside the fixing portion and electrically connected to a light source; and the light diffusion portion 162 disposed outside the fixing portion to diffuse light emitted from the light source.

The control panel may partially cover a front side of the housing, the knob may be movable between the first knob position and the second knob position moved rearwardly from the first knob position, and the cooking apparatus may further include the regulator 200 disposed on a rear side of the control panel to operate the heat source in response to the rotation of the knob, the shaft 300 coupled to the regulator to be movable from the first shaft position in which rotation with respect to the regulator is restricted at the first knob position of the knob to the second shaft position rotatable with respect to the regulator at the second knob position so as to operate the heat source, the fixing protrusion 320 protruding from the shaft in a radial direction of the shaft, and the fixing groove 211a formed in the regulator to receive the fixing protrusion while the shaft is positioned at the first shaft position, wherein, based on the knob being moved toward the control panel, the shaft may be moved to the second shaft position.

The cooking apparatus may further include the processor 1100 configured to cause the regulator to generate a signal based on the rotation of the knob, and to operate the heat source in response to the signal generated by the regulator.

The cooking apparatus according to an embodiment may include the housing 10, the heat source 90 provided on one side of the housing, the control panel 41 coupled to the housing, the knob 110 rotatably mounted on the control panel so as to operate the heat source, the button 120 movably coupled to the knob, the stopper 150 disposed between the control panel and the button and including the anti-rotation portion 151 configured to prevent rotation of the knob, and the locking pin 130 secured to the button so as to be received in the anti-rotation portion and configured to prevent the rotation of the knob while the locking pin is received in the anti-rotation portion.

The button may include the first pressing portion 121a and the second pressing portion 122a, and the spring 123 disposed between the first pressing portion and the second pressing portion to allow the locking pin to be moved from an unlocking position to a locking position.

The button may include the first rack 121c extending from the first pressing portion toward the second pressing portion, the second rack 122c extending from the second pressing portion toward the first pressing portion, and the pinion 124 disposed between the first rack and the second rack so as to be rotatable based on the first pressing portion and the second pressing portion being pressed.

The cooking apparatus according to an embodiment may include the housing 10, the heat source 90 provided on one side of the housing, the control panel 41 covering a portion of a front side of the housing, the knob 110 mounted on the control panel so as to operate the heat source and configured to be movable toward the control panel, the button 120 movably coupled to the knob, the pin 130 including the first pin position P1 secured to the button so as to be moved based on the button being moved and the second pin position P2 moved from the first pin position based on the button being moved, and the stopper 150 disposed between the control panel and the button and including the anti-rotation portion 153 contactable with the pin at the first pin position of the knob to prevent the knob from moving toward the control panel, wherein based on the knob 110 being moved toward the control panel 41 and the pin 120 being at the second pin position, the knob may be rotated.

The stopper 150 may include the hollow portion 150b and the wall 150a forming the hollow portion, and the anti-movement portion may protrude from the wall toward the hollow portion and may not be in contact with the pin at the second pin of the pin.

While the present disclosure has been particularly described with reference to exemplary embodiments, it should be understood by those of skilled in the art that various changes in form and details may be made without departing from the spirit and scope of the present disclosure.

What is claimed is:

1. A cooking apparatus, comprising:
a housing;
a heat source on one side of the housing;
a control panel couplable to the housing;
a knob rotatably mountable on the control panel to operate the heat source and movable rearwardly;
a stopper between the control panel and the knob, the stopper including an anti-rotation portion configured to prevent a rotation of the knob;
a button movably couplable to the knob in a left-to-right direction; and
a locking pin accommodated in the anti-rotation portion and secured to the button so as to move along the button; and
wherein the locking pin is deviated from the anti-rotation portion based on a movement of the button,
the knob is rotatable while the knob is moved rearwardly and the locking pin is deviated from the anti-rotation portion, and
the knob is rotated to operate the heat source.

2. The cooking apparatus of claim 1, wherein the rotation of the knob is prevented while the locking pin is accommodated in the anti-rotation portion.

3. The cooking apparatus of claim 2, wherein
the locking pin is movable between a first pin position in which the rotation of the knob is locked by being accommodated in the anti-rotation portion and a second pin position in which the rotation of the knob is unlocked by being deviated from the anti-rotation portion, and
the anti-rotation portion includes a stopper groove in which the locking pin is accommodated at the first pin position of the locking pin, and
while the button is moved in the left-to-right direction, the locking pin is moved from the first pin position to the second pin position to allow the locking pin to be deviated from the stopper groove.

4. The cooking apparatus of claim 3, wherein
the button is configured to rotate along the knob at the second pin position of the locking pin,
after the knob and the button are rotated at a predetermined angle, the locking pin is movable to the first pin position.

5. The cooking apparatus of claim 4, wherein the knob and the button are rotatable while the locking pin is at the first pin position after the knob and the button are rotated at the predetermined angle.

6. The cooking apparatus of claim 3, wherein the stopper comprises:
a hollow portion;
an perimeter wall forming the hollow portion; and
a protruding wall protruding from the perimeter wall and on which the stopper groove is formed.

7. The cooking apparatus of claim 3, wherein the button comprises:
a first pressing portion and a second pressing portion arranged in one direction;
a first rack extending from the first pressing portion toward the second pressing portion;
a second rack extending from the second pressing portion toward the first pressing portion; and
a pinion disposed between the first rack and the second rack so as to be rotatable based on the first pressing portion and the second pressing portion being pressed.

8. The cooking apparatus of claim 7, wherein the button further includes a spring disposed between the first pressing portion and the second pressing portion to press the first pressing portion and the second pressing portion.

9. The cooking apparatus of claim 8, wherein
the control panel is disposed on a front side of the housing, and
the button further comprises:
a first guide portion extending in left-to-right direction from a rear end of the first pressing portion;
a second guide portion extending in left-to-right direction from a rear end of the second pressing portion; and
a guide groove formed in the first guide portion and the second guide portion in the left-to-right direction to guide the movement of the first pressing portion and the second pressing portion.

10. The cooking apparatus of claim 9, further comprising a weight disposed on a front side of the stopper,
wherein the weight comprises:
a base; and
a guide rail protruding from the base toward the button and arranged in the left-to-right direction so as to be inserted into the guide groove.

11. The cooking apparatus of claim 7, wherein
the knob includes a receiving space configured to receive the button, and
the first pressing portion and the second pressing portion are exposed from the receiving space to be pressed.

12. The cooking apparatus of claim 7, further comprising a weight disposed on a front side of the stopper,
wherein the weight comprises:
a base;
a pinion mounting portion protruding from the base to allow the pinion to be mounted; and
a guide hole formed in the base to guide the movement of the locking pin.

13. The cooking apparatus of claim 12, further comprising a stopper holder coupled to the control panel to secure the stopper,
wherein the stopper holder comprises:
a fixing portion to which the stopper is secured;
a light source substrate disposed outside the fixing portion and electrically connected to a light source; and
a light diffusion portion disposed outside the fixing portion to diffuse light emitted from the light source.

14. The cooking apparatus of claim 1, wherein
the control panel is configured to partially cover a front side of the housing, and
the knob is movable between a first knob position and a second knob position moved rearwardly from the first knob position, and
the cooking apparatus further comprises:
a regulator disposed on a rear side of the control panel to operate the heat source in response to the rotation of the knob;
a shaft coupled to the regulator to be movable from a first shaft position in which rotation with respect to the regulator is restricted at the first knob position of the knob to a second shaft position rotatable with respect to the regulator at the second knob position so as to operate the heat source;
a fixing protrusion protruding from the shaft in a radial direction of the shaft; and
a fixing groove formed in the regulator to receive the fixing protrusion while the shaft is positioned at the first shaft position,
wherein, based on the knob being moved toward the control panel, the shaft is moved to the second shaft position.

15. The cooking apparatus of claim 14, further comprising a processor configured to control the regulator to generate a signal based on the rotation of the knob, and to operate the heat source in response to the signal generated by the regulator.

16. A cooking apparatus, comprising:
a housing;
a heat source on one side of the housing;
a control panel coupled to the housing;
a knob rotatably mounted on the control panel so as to operate the heat source;
a button movably coupled to the knob;
a stopper between the control panel and the button and including an anti-rotation portion configured to prevent a rotation of the knob; and
a locking pin secured to the button so as to be received in the anti-rotation portion and configured to prevent the rotation of the knob while the locking pin is received in the anti-rotation portion.

17. The cooking apparatus of claim 16, wherein the knob is movable between a first knob position in which rotation is prevented, and a second knob position moved in a first direction from the first knob position, the button is movable in a direction different from the first direction between a first button position in which the pin is locked by the stopper to prevent the rotation of the knob, and a second button position in which the pin is unlocked from the stopper, and based on the knob being at the second knob position and the button being at the second button position, the knob is rotated to operate the heat source.

18. A cooking apparatus comprising:
a housing;
a heat source on one side of the housing;
a control panel to cover a portion of a front side of the housing;
a knob mounted on the control panel so as to operate the heat source and configured to be movable toward the control panel;
a button movably coupled to the knob;
a pin including a first pin position secured to the button so as to be moved based on the button being moved and a second pin position moved from the first pin position based on the button being moved; and
a stopper between the control panel and the button and including an anti-rotation portion contactable with the pin at the first pin position of the knob to prevent the knob from moving toward the control panel,
wherein based on the knob being moved toward the control panel and the pin being at the second pin position, the knob is rotated.
